(19) United States
(12) Patent Application Publication
(10) Pub. No.: US 2021/0342800 A1
(43) Pub. Date: Nov. 4, 2021

(54) SYSTEM AND METHOD FOR AUTOMATIC PAYMENT DISTRIBUTION USING LEAFBILL

(71) Applicant: Grace Tang, Stockton, CA (US)

(72) Inventor: Grace Tang, Stockton, CA (US)

(21) Appl. No.: 16/866,542

(22) Filed: May 4, 2020

(51) Int. Cl. G06Q 20/12; G06Q 50/18; G06Q 30/00; G06Q 10/10; G06Q 20/20; G06Q 30/06; G06Q 20/38; G06Q 40/02; G06F 16/27; G06K 7/14; G06F 3/12

(52) U.S. Cl. CPC G06Q 20/1235; H04L 9/14; G06Q 50/188; G06Q 30/0185; G06Q 10/105; G06Q 20/209; G06Q 20/202; G06Q 30/0643; G06Q 30/0633; G06Q 20/3829; G06Q 40/02; G06F 16/27; G06K 7/1413; G06K 7/1417; G06F 3/1243; G06F 3/1205; G06F 3/1255; G06Q 2220/123; G06Q 30/0621; G06Q 50/184

(57) ABSTRACT

A system and method for enabling an automated contract recording and payment distribution to contributors of a product line according to a process of automatic recording payment addresses, transactions, contracts and state transitions of contracts, enabling automatic payment distribution using a plurality of algorithms, digital smart contracts and digital ledgers via custom configured computer systems in a peer-to-peer blockchain computer network. A system and method to create a flexible, visible and transparent way to award individual contributors for their add-on works as part of the sell of an enhanced product.

### CROSS-REFERENCE TO RELATED APPLICATIONS

This application is a continuation-in-part of application Ser. No. 14/800,655, Filed Jul. 15, 2015, entitled “SYSTEM AND METHOD FOR LEAFBILL”, naming Grace Tang as the inventor.

### BACKGROUND OF THE INVENTION

### 1. Field of the Invention

This invention relates generally to a system and method for enabling an automated contract recording and payment distribution to contributors of a product line. More particularly, the invention relates to a system and method for recording contributions made by individual contributors who create add-on values to enhance products and making automatically payment distributions to said individual contributors upon the sell of the products.

### 2. Description of Prior Art

Our economics system is vital for the prosperity of human society. Since human starts trading, we have gone through many innovations and improvements, adjusting our economics system to our ever changing environment.

The optimized productivity aided by advanced technologies brings many changes into our environment, and requires us to improve our economics system to adapt to these changes.

My invention helps people creating add-on values to enhance products and provide ways to reward their contributions.

The analysis included in this document is based on the observation of the trends of current and future development in various technology fields, various markets, and our economics system. Charts over a historical timeframe are included in this document, they are based on this analysis and assumptions made on top of the observation of facts. It is subject to improvements in the future.

### SUMMARY OF THE INVENTION

A system and method for enabling an automated contract recording and payment distribution to contributors of a product line according to a process of automatic recording payment addresses, transactions, contracts and state transitions of contracts, enabling automatic payment distribution using a plurality of algorithms, digital smart contracts and digital ledgers via custom configured computer systems in a peer-to-peer blockchain computer network. More particularly, the invention relates to a system and method for recording contributions made by individual contributors who create add-on values to enhance products and making automatically payment distributions to said individual contributors upon the sell of the products. A system and method to create a flexible, visible and transparent way to award individual contributors for their add-on works as part of the sell of an enhanced product.

### BRIEF DESCRIPTION OF THE DRAWINGS

For a more succinct understanding of the nature and objects of the present invention, reference should be directed to the following detailed description taken in connection with the accompanying drawings in which:

FIG. 1 is a chart illustrating estimated growth rate for machine productivity and human reproductivity over a historical timeframe.

FIG. 2 is a chart illustrating estimated percentage of exchangeable human resources vs. exchangeable resources produced by machine in our economics system over a historical timeframe.

FIGS. 3A and 3B are charts illustrating estimated efficiency of fulfillment of demands in our economics system over a historical timeframe.

FIGS. 4A and 4B are diagrams illustrating the concept of the formation of optimized productivity.

FIG. 5 is a diagram illustrating the concept of adverse price competition cycle.

FIG. 6 is a diagram illustrating the cost-plus retail pricing model.

FIG. 7 is a diagram illustrating using add-ons to increase the perceivable value of product for customers.

FIG. 8 is a diagram illustrating the Prime Elements of Purchase, and the impact of saturated market on these elements.

FIG. 9A, 9B, 9C are diagrams illustrating product driven market, demand driven market and balanced market.

FIG. 10 is a chart illustrating the market consumption volume for a product.

FIGS. 11A and 11B are diagrams illustrating two examples of Leaffiills.

FIGS. 12A, 12B, 12C and 12D are charts illustrating the impact of mass production on the value of product, and the effect of increasing perceivable value of product using add-ons.

FIG. 13 is a diagram illustrating the instillment of add-on values for generic products.

FIG. 14 is a block diagram illustrating an embodiment of a LeafBill system.

FIGS. 15A and 15B are two diagrams illustrating detachable leaf and non-detachable leaf.

FIG. 16 is a diagram illustrating another embodiment of Leaffiill.

FIGS. 17A and 17B are diagrams illustrating an example of using Leaflet to order and/or purchase add-on services, and using barcode and QR code on the Leaflet.

FIG. 18 is a diagram illustrating using a virtual fitting system to select and visualize add-on components and/or features on top of a picture of the consumer's space, make the purchase, and print out the LeafBill using said system.

FIG. 19 is a diagram illustrating an embodiment of LeafBill using unique identifiers for the product line and payment addresses.

FIG. 20 is a diagram illustrating an embodiment of LeafBill using placeholder leaf.

FIG. 21 is a diagram illustrating an embodiment of LeafBill that has one product line.

FIG. 22 is a diagram illustrating another embodiment of LeafBill that has two branches, with two different custom product branches extending from the main base product branch.

FIG. 23 is a diagram illustrating an embodiment of LeafBill showing that the sum of payment distributions to individual contributors equal to the total payment received at that payment address of the product line.

FIG. 24 is a flowchart illustrating the process of using LeafBill to record the offer, acceptance, consideration and mutual agreement process of the contract for adding a contributor to a new product line.

FIG. 25 is a flowchart illustrating the process of using LeafBill making automated payment distribution to individual contributors upon receiving payment from selling the product.

FIG. 26 is a flowchart illustrating the process of using LeafBill making automated payment distribution to individual contributors bases on their roles upon receiving payment from selling the product.

FIG. 27 is an illustration of an embodiment of a LeafBill system in a peer-to-peer blockchain computer network.

FIG. 28 is an illustration of an embodiment of a contract used in LeafBill system.

FIG. 29 is an illustration of an embodiment of a unique identifier.

### DETAILED DESCRIPTION OF THE INVENTION

While the present invention may be embodied in many different forms, designs or configurations, for the purpose of promoting an understanding of the principles of the invention, reference will be made to the embodiments illustrated in the drawings and specific language will be used to describe the same. It will nevertheless be understood that no limitation of the scope of the invention is thereby intended. Any alterations and further implementations of the principles of the invention as described herein are contemplated as would normally occur to one skilled in the art to which the invention relates.

### The Problem

The intended purpose of money is to transfer value from one entity to another. People need to exchange their services and goods with other people, so that they can receive different services and goods with equivalent and/or similar value. The liquidity attribute of money allows it be carried, stored and transferred among entities with ease. Money is the media that people and entities in human society use to quantify and exchange their resources. It is one of the fundamental elements in our economic system.

Part 1: The Purpose of Money

Money is used to quantify, measure and exchange for different types of resources. This includes materials, such as diamonds and gold; usage of geographical location, such as a lease owned retail store; privileges in human society, such as membership of certain clubs; visibility in human society, such as publicity among different social groups; and human resource, such as the hours that one person work for another; and many other types of resources. In short, money can be used to quantify and exchange for things in various aspects of what, when, where, why, how and who.

Part 2: Our Economic

A healthy economic system is based on the assumption that: Amount of money transferrable in the economic system=Amount of resources transferrable in the economic system

However, in model age, with the technology advancement and easy distribution of information, it becomes increasingly easier to produce large quantities of products with little resource. For example, one person with a few 3D printers can print out enough golf balls to supply the entire city.

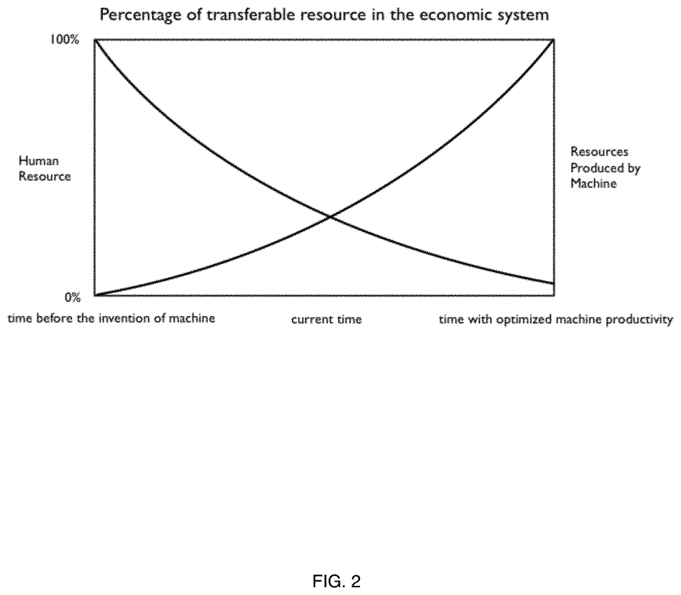

The accumulation of materials is happening in a much faster pace than the accumulation of time. If we look at the growth rate of exchangeable resources available in the market, we can get a better picture FIG. 2.

With the advancement of technology, productivities are improving at an exponential rate. This was observed in the Moore's Law, that “over the history of computing hardware, the number of transistors in a dense integrated circuit has doubled approximately every two years.” In general, this observes that that the computation power has an exponential growth rate over the years. Empowered by this and other factors, our productivity grows exponentially over the years.

In general, people are being able to make things much easier, faster and better over the years. This exponential growth of productivity is powered by machines and/or robots, process automation and computation power; and it is irreversible.

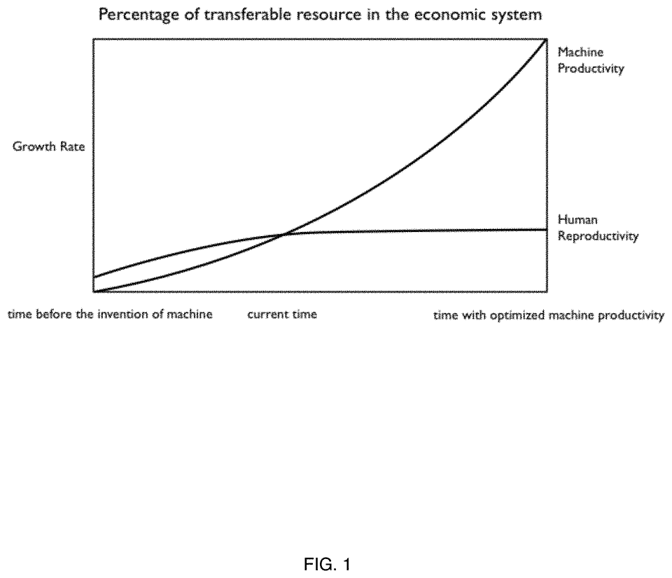

Compare to machine's productivity power, human reproductivity are limited by the organic nature of human beings. A baby needs to be conceived, carried to full-term, born and raised to become an adult who possesses the reproduce power. In modern age, it is quite normal for people to produce kids at age ranging from 20 s to 45 s. If we use 30 years as the average number of years for a human being to produce one kid, or two kids per couple, that is 1× growth over 30 years, assuming a couple producing two children on average. This is illustrated in the FIG. 1.

As we mentioned earlier, money can be used to exchange and transfer time, such as the hours a person works for another. A person's time is a portion of his/her life. A person produce qualified working hours only in his/her adult life. This is referred as human resource here.

If we look at the entire economics system, that consists both machine made resources and human resources, both are quantified and made exchangeable through money transfer in the economic system, we can see the trend over the historical timeframe, illustrated in FIG. 2.

Part 3: Adverse Competition in the Market

One of our human nature is that people always want better things at lower price.

With the enhanced productivity, aided by advanced technologies, an increasing amount of products are being delivered to the market. This may disrupts our market and our economics system.

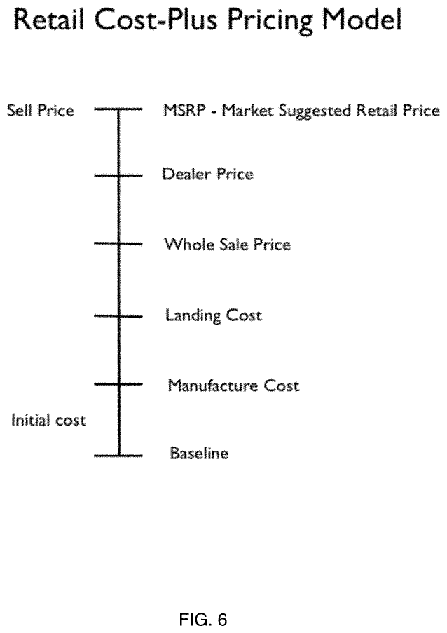

With our current retail system, when a consumer buys a product, he/she pays the price for that product to the retailer. Retailer usually charges at MSRP (market suggested retail price) for that product. Using the money received from customers, retailer refills his/her inventory from the product distribution chain. In turn, each entity along the product distribution chain receives its portion of benefits from the sell as add-on cost. These entities include the designers who designed the products, manufacture who produced the products, logistic company who shipped the products, distributors, wholesalers, dealers, retailers and etc. (FIG. 6)

However, with the boost in productivity and expansion in mass production, this cycle is being disrupted, and the impacts become increasingly visible in the retail market.

Mass production creates mass amount of generic machine made products available to sell in the market. This intensifies the competition among similar generic products in the market. It also intensifies the competition between retailers.

Retailers are forced to offer the lowest price possible to attract customers. The purchase source (the Who element) of where the customers buy the products no longer matters that much. Consumers can buy the same generic product from multiple places. In most cases, they will buy the products from the retailer who offers the lowest price, and often, the lowest price are offered by online e-retailers.

This disrupts the entire product distribution chain. Because brick and mortar retailers has higher cost, including the cost of the physical store location, store staff, utilities, inventory stocking and etc. Having these additional costs, these retailers often cannot offer the lowest price for the same generic products that are also available to purchase online.

Sometimes, manufactures, brick and mortar retailers and e-retailers may reach a consent, and list the same product at the same price both online and in-store. But the net profit from the sell of the same product will be lower for the brick and mortar retailers, because of the additional costs of their physical stores.

At the same time, if said consented price of said generic product is higher than similar products, consumers tend to find a similar product that is offered on the market at a lower price. The adverse price competition is not only across the same product line, or the same brand, it is across all similar products lines, and all similar brands.

If generic made products only has marginal difference in style, quality and brand recognition, they will be forced to compete in price. Whichever has the lowest price will get the sell.

Because of the brick and mortar retailers have more add-on costs than e-retailers, they often can not offer the lowest price, and can not attract large quantities of customers by selling generic goods at higher price tags.

Without a healthy sales flow, the inventory is stocked up in the store for a long time, become out of trend, which makes it even harder to attract customers to come to their stores to purchase these out of trend generic goods. Retailers' working capital gets tied up by these generic inventory goods that can not sell, and don't have enough free cash flow to refresh their inventory. This situation is getting worse with the passing of time.

This adverse competition in pricing also causes another serious problem.

Because prices are pushed down to as low as possible, most retailers tend to offer generic machine made products at cost. The competition in price turns into a competition in cost. This significantly limits how much human resource they want to invest in their products, so that they can lower the cost of goods. This decision leads to reduction in labor cost, and reduction in human resource employed in the production, distribution and retail chain.

This pattern matches with the pattern in FIG. 2, that in our economic system, transferrable and/or sellable goods will require a lesser and lesser percentage of human resource contribution.

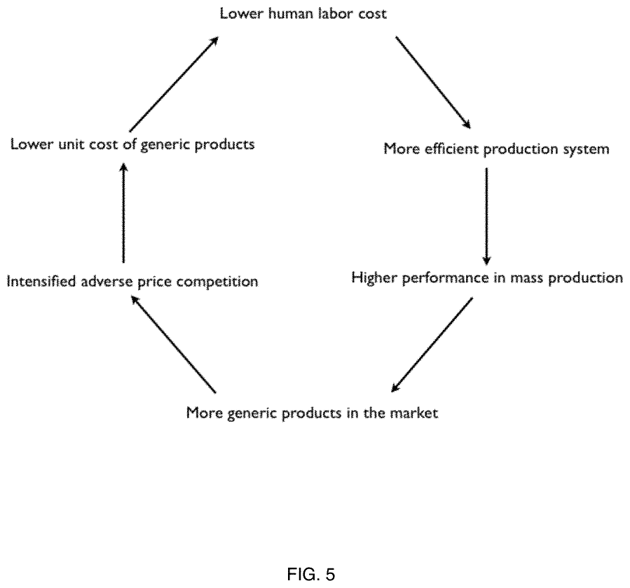

In FIG. 5, it shows that with advance of technology, the production system becomes more efficient, it enables higher performance in mass production. This delivers more mass produced generic products to the market, ready to sell. Because the market is limited by its consumption rate, the abundance of the generic products in the market reduces their scarcity, lower their perceivable value to the customers, and intensifies the price competition to induce sell. The harsher price competition leads to lower pricing of said generic products, and leads to reduction of human resource involved in the production, distribution and retail chain. This in turn, creates more incentive to improve the production system with more advanced technology, to make it more efficient in producing more products with less resource.

It is an adverse cycle keep evolving, intensifying the competition in the market, driving down prices, and reducing resources involved in the process. This cycle is adversely affecting the retail market, deteriorating the market condition, and forcing many retailers out of business.

Part 4: The New Generation of Products

With advance technology, our productivity is increasing at an exponential rate. There is any exponentially growing amount of finished products being delivered to the market, and the repair and/or replacement of these products are getting cheaper and easier. Damaged products are repaired and/or refurbished into like-new condition.

For example, if the original product is assembled with parts created with 3D printing, it will be very easy to print out that part of the product using 3D printing, and replace the damage part with the newly printed one. Since both parts are printed out using the same 3D model, it will be a perfect match, and the repaired products will work like new ones.

Thus the new generation of products may always in like new condition. They are easy to duplicate, easy to repair, easy to clean, easy to maintain products, and they will be created in massive quantities.

If a product is printed using recyclable materials, the cost of melting an old product into its original material, purify it, and reuse that material to print out a new product will be very easy. In this case, we will always have new products to use. This means that this new generation of products will have unlimited shelf life, unlimited product life span, and will already be ready to use at brand new condition. They have many advantages over older generation of products.

Part 5: Optimized Productivity

We are at an age when technologies are advancing in an increasing faster pace in multiple dimensions. Computation power, 3D printing, robotics, artificial intelligence, material science and many other fields are all advancing at a fast pace. If we look into it, we will find that a super production power are being incubated, and will be formed.

This super production power will enable optimized productivity, and bring it into the market. It will be enabled by 3 major advance technologies.

The 3D printing technology can print out massive amount of components, using various 3D models designed to fulfill specific needs. 3D printers can print out these components anytime and anywhere.

Robots and automated assembly lines can be used to assemble these components, and put them together into final products.

Computation power can be used to control the 3D printers, robots, and the assembly lines, to manufacture, packaging and deliver these products to customers.

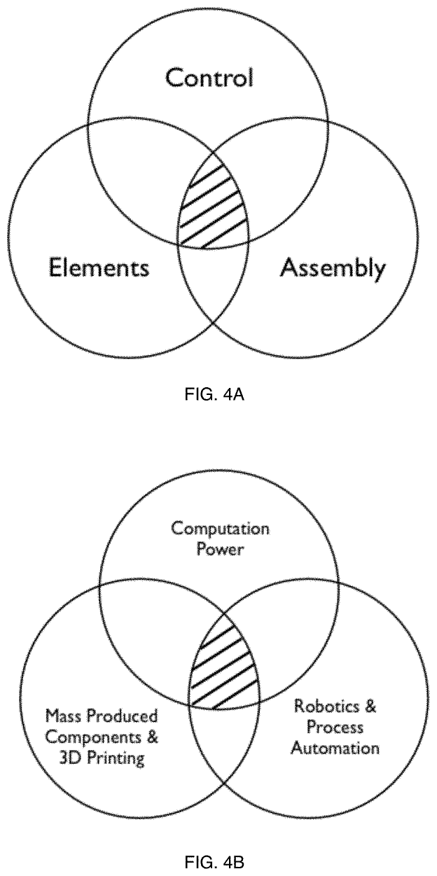

With the combination of these three advanced technologies, we can achieve optimized productivity. This is illustrated in FIGS. 4A and 4B.

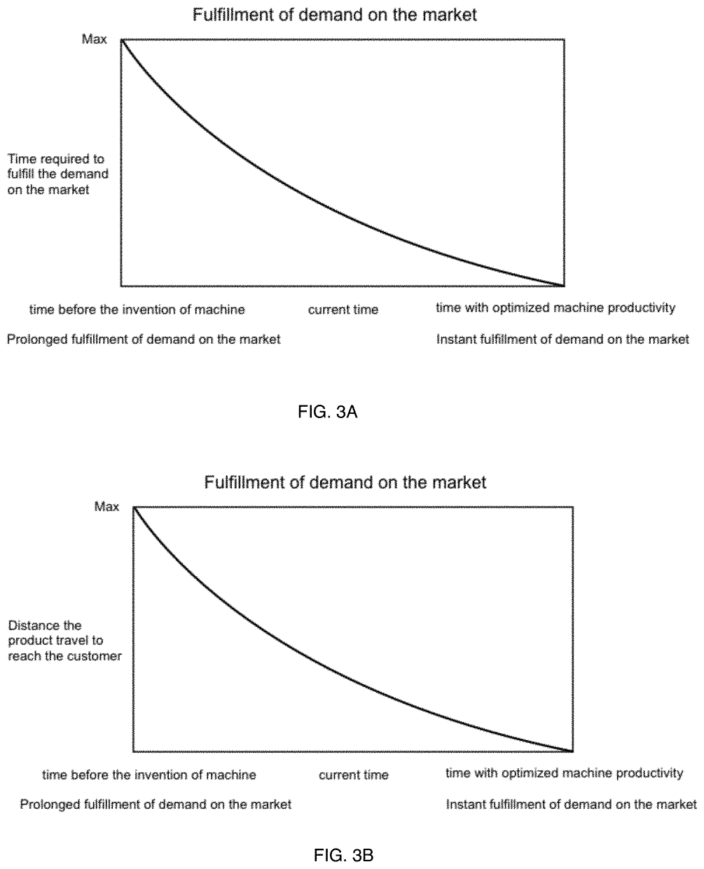

When optimized machine productivity is reached, theoretically, machine could produce all the generic products in our economic system. Theoretically, this will result that all generic products that could be consumed in our economic system are created through machine, made available to consumers when needed. This is an instant fulfillment of demand in the market, or in other words, a fully satisfied consumer market. This is illustrated in FIGS. 3A and 3B.

Part 6: Prime Elements of Purchase

Like water, for it to flow from one place to another, there must be a reason. Water finds its way from the top of the mountain to the bottom of the ocean, because there is a gap in the elevation, water are attracted by gravity.

For money transaction to take place, one party wants to exchange money and/or resource with another party, it needs to have its reason. We commonly call this incentive to purchase or reason to buy.

If we look at what are these reasons, we can summarize them into 6 major elements, including the uniqueness of the product, what to buy, time to buy, location to buy, how to buy and buy from whom. Interestingly, it is covered by the six prime elements of purchase of What, When, Where, Why, How and Who.

People want to buy things that they don't have. In ancient time, this is the reason why merchants travel long distance to purchase salt, and trade them inland at a much higher price, because it is hard to find salt at places far away from the sea. It takes time to travel long distance, there is a gap in the market to ensure the transaction can take place. Because people are willing to use money to trade for the resources. In its physical form and/or its tangible asset, the product is salt. What's also included in the product and the transaction are the intangible assets, the invisible add-on value, that is the time and resource the merchant spent to travel the distance for obtaining the salt.

Using advanced technology, people can create generic products with ease. Just like people can download a picture from the internet and printed it out on a paper in seconds; it will be very easy for people to download a 3D model data file from the internet and print it out using a 3D printer in the future.

This means generic products can be easily made by anyone, anywhere in the future.

This means that the market gap for generic products is small. Because anyone can print out generic products at anywhere, people don't need to order it from vendors far away, they can order it from print shops in their neighborhood, or print out at home. The time, distance and how elements for the transaction are removed.

Generic products are duplicated copies, the uniqueness and/or the What element for the transaction are removed.

Anyone will be able to print out generic products, so the Who element for the transaction are also removed.

Why will a person buy things from other people if they can produce them themselves? People want to buy things that they don't have, they don't want to buy things that they already have. So the Why elements for the transaction are also removed.

With optimized productivity, entities in our economics system are self-sustained, and we can use the productivity to produce generic products locally.

With optimized productivity, all Prime Elements of Purchase, and/or elements for a transaction to occur are dissolved, except a few fundamental exceptions. Our geographical locations are unique, our natural resource allocations are unique, our culture is unique, and our human resources at each location are unique.

Part 7: Productivity and Consumption

While productivity power aided by machine can be increase exponentially, and limitlessly, human beings are limited by our organic physical bodies.

Our bodies are organic; we have a limited life span. We can eat limited amount of food everyday, consume limited amount of energy everyday. Although our mind, voices and images travels freely through the internet, our physical bodies are located at one place at a time. As consumers, we can consume limited amount of resource everyday.

This means that the consumption power is limited in our economics system. It is limited by the human population in this world, and it is limited by how much resource human beings can consume. The global human population growth is about 1.1% per year, and more developed countries have less growth rate. With the advancement of the technology and its distribution to undeveloped countries, it is possible that the birthrate of human population will be in the vicinity of replacement rate in the next century.

Although human consumption rate may stabilize, our productivity has an exponential growth rate. Human productivity will outpace human consumption at some point of time in the future FIG. 1.

In our economics system, the value and/or asset transfer is completed when a product is consumed. Without consumption, transaction will not take place. This means our economics system will sustain enough transactions such that all consumption will be fulfilled by productions. Our economics will be stabilized and balanced at a threshold that is defined by human population's consumption rate.

Amount of Sellable Products=Amount of Consumable Products

Part 8: Market Types

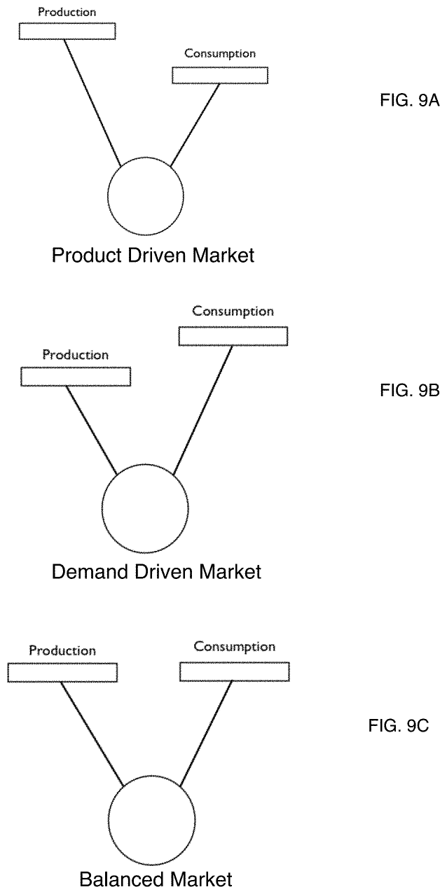

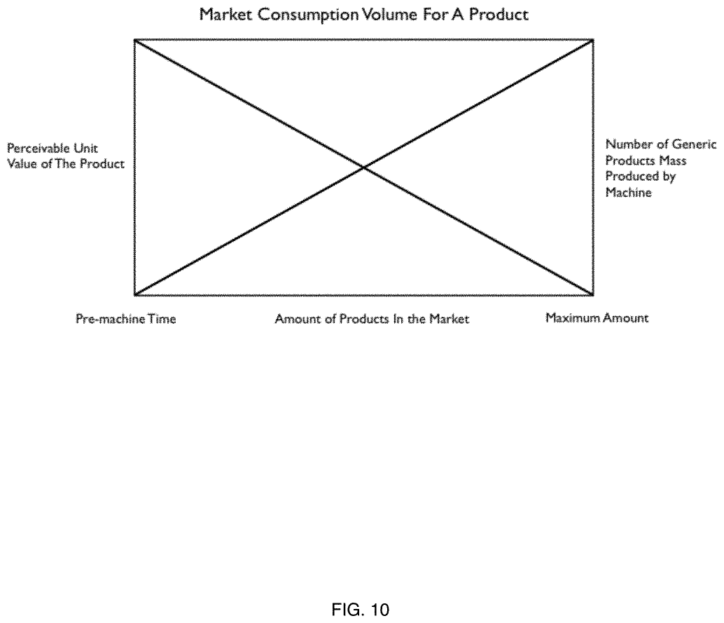

In a product driven market, there are many consumers seeking products to fulfill their needs FIG. 9A. The transaction volume depends on how many products are available to fulfill the market need for said products. As soon as the products are manufactured and made available to the market, they are brought by customers who are waiting to purchase them. There is a market demand for said products, the driving factor is the availability of the products. Merchants make profits from customers' increased perceivable value of the products, which is affected by the scarcity of said products.

In a demand driven market, there are more products in the market and they have to compete for customers for transactions to take place. Merchants seek out the customers who are willing to pay for said products. Merchants make profits from the sell depending on how much consumers willing to pay for said products FIG. 9B.

In a balance and/or saturated market, consumer demands in the market are immediately fulfilled by production of the products. The market gap is narrow, and can be fulfilled and balanced soon after it shows up FIG. 9C.

Part 9: Production Approach, Income and Expenditure Approach

Gross domestic product (GDP) is defined as “an aggregate measure of production equal to the sum of the gross values added of all resident, institutional units engaged in production”. GDP estimates are commonly used to measure the economic performance.

GDP can be determined in three ways, all of which should, in principle, give the same result. They are the production approach, the income approach, or the expenditure approach (Wikipedia).

The most direct of the three is the production approach, which sums the outputs of every class of enterprise to arrive at the total. The expenditure approach works on the principle that all of the product must be bought by somebody, therefore the value of the total product must be equal to people's total expenditures in buying things. The income approach works on the principle that the incomes of the producers must be equal to the value of their product, and determines GDP by finding the sum of all producers' incomes.

In a product driven market, the production approach is commonly used to measure the economic performance, because the balance of transferable resources in the economic system is limited by the amount of produced products in the market.

In a demand driven market, the income approach and expenditure approach need to have the focus. Because the balance in the economic system is limited by the amount of consumer demands and/or amount of resources available for the consumers to make the expenditure.

Amount of Sellable Production=Amount of Consumption

In its original design, all three ways to measure GDP shall give the same result. However, with the exponential growth of productivity, the production approach will have a higher grow rate than the income approach and expenditure approach, as indicated in FIG. 1. This gap between production approach, income and expenditure approach will be widened with the advancing of new technologies, its impacts will become increasingly visible in our economy in the future.

Part 10: The New Market

What will be the new market? What make people want to buy things from another entity? It comes down to the fundamental question: Why people buy?

People want to buy the things that they don't have, that make them looks better and feel better about themselves.

We are each unique beings, always seeking things to improve our lives. Because we are unique, the ways we look at things are unique, the ways we think about things are unique.

In a saturated market, things that we can easily have such as generic products lost their scarcity for us. We want interesting things that we make us feel special about ourselves. Time and environment will not change our nature, that we human beings, like to explorer things and possess things that make us feel better. And that's the engine for commerce in this new market.

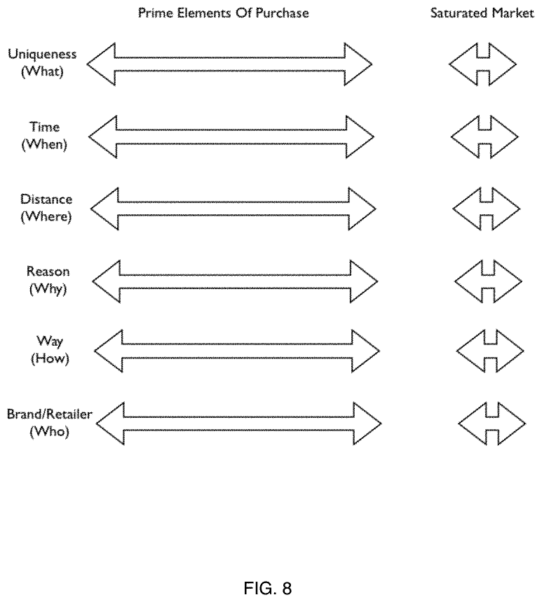

If we look at FIG. 8, in this new market, the transaction will still be governed by the six elements What, When, Where, Why, How and Who.

Our incentive to buy will be based on the uniqueness of the product. Is a product unique, whether it make that consumer looks better and feels better will decide whether he/she wants to buy that product.

Although consumers can print out generic products at home, we human being are social beings. We like to connect with people, and receive services from other people. We are physical beings, this limits where we can receive services in person. For example, a local restaurant has regular customers visiting the restaurant, because people have to be physically present at the restaurant to eat. A makeup artist has regular clients, because people put makeup on their faces. This can be concluded as local service providers who provides custom in person services. These are the When, Where, How and Who elements of the Prime Elements of Purchase.

For products to differentiate themselves from generic products, they need to be unique. Either they are customized or tailored to specifically suite the needs of individual customers, or they have a design, feature or character that make them different from generic products mass produced by machine. This needs to be solved for the What and Why Elements of Purchase. There are and will be many techniques to solve this.

Part 11: A Healthy Economy

A healthy economic system is based on the assumption that:

Amount of Money Transferrable in the Economic System=Amount of Resources Transferrable in the Economic System

In a balanced market, where the consumption limits the amount of transactions in the economic system, it will be very important to ensure that the we have a healthy consumption rate in the economic system. Because with more consumer consumption, the market creates more transactions and has more energy. Just like a human being has blood constantly circling inside his/her body, and keep all body parts nurtured and alive. A healthy economics system needs constant circling, refreshing, allocating and rearranging resources to stay healthy. We need an energetic market for all parts of our society to prosper. People exchange resources with each other, so that we all have a full spectrum of resources to use, all entities in our society can stay healthy and prosper.

By our organic nature, we human beings live, travel and entertain, and we create consumptions in our economics system. This is different from machine. Once a machine is made, the cost of maintaining a machine in its working state is very low. In the future, when the energy cost is low, the cost of running and maintain a machine is almost zero. Thus a working machine does not generate consumption in our economics system.

In a demand driven market, or a balanced market, the health of the economics system will be determined by our consumption, which means it will be determined by how much human beings consume. The better living standard we have in our society, the healthier consumption, the better economy.

To ensure this healthy consumption, we need to ensure that all human beings have the access, incentive and means to exchange resources with other people.

We, human beings, like to have things that make us look better, feel better about ourselves. We, human beings, like to work on things that we are interested in, things that make us unique. Things make us unique are not mass produced by machines.

The solution is created when we provide the means for a common person to transfer his/her unique tangible and/or intangible assets into products, or infuse them as add-ons to generic products, make them sellable and transferrable, so that people can easily exchange resources with other people, receive the benefits for their work and contribution.

This is the reason for this invention.

### The Solution

Part 12: Price Segmentation

In ancient times, pearls were very rare, had high value, and were used to exchange for diamonds and precious stones. Then human beings find a way to mass produce pearls using oyster farms. Since then, the price of pearls dropped significantly, because they are no longer scarce.

For mass produced products, the same rule applies. Mass production causes the products to loss their scarcity. If one thousand glasses are mass produced and selling in the market, and there are only five hundred people in the town, these glasses will overload the market. Not only the glasses could not hold its value, but also it disrupts the market and waste the resource it used. It takes resource to produce and stock these glasses. When the glasses can not sell, they hold the resource in a congested state, as stagnant inventory piled up in the warehouse.

More importantly, these congested mass produced products cause the human resource instilled into these products stay in a congested, unpaid state. If a factory can not sell its products for a long time, it can not pay its employees. If a store can not sell its products for a long time, it can not keep its business afloat, and will have to close business. Human beings can not live without resource. We are organic beings that constantly consume resources to stay alive.

To solve this mass production issue, we have to separate the mass produced assets from the tangible and intangible assets instilled by human in the product. And we have to adjust the price of the product based on its scarcity and uniqueness.

This way, we can properly value and compensate human beings' contribution, and adjusting the price of the products according to said contribution to maintain a healthy economy.

There are multiple ways to segment and adjust the price of the product based on its scarcity and uniqueness, and provide an organic way to prevent market congestion.

Part 13: Add-On Values

The perceivable value of products can be significantly increased through add-on components, features and product customization.

In a demand driven market, the when, where, how and who factors no longer limits how consumers make their purchase decision. One way for products to stand out and make strong sales, is to be customized or tailored to specifically suite the needs of individual consumers. They may have a design, feature or character that make them different from generic products mass produced by machine. This boosts the What and Why factors to induce the purchase.

When a distributor and/or retailers offer high quality on-going service, to customize and tailor the products to suite the needs of individual customers, they attract more customers to visit their stores and buy from them. This boost the when, where, how and who factors in the Prime Elements of Purchase.

Most importantly, these customized and tailors services are often have creative elements, and require sophisticated inter-personal skills. These services are provided by store assistants, service providers, and/or other human resources. These services offer abundant work opportunities for human workers.

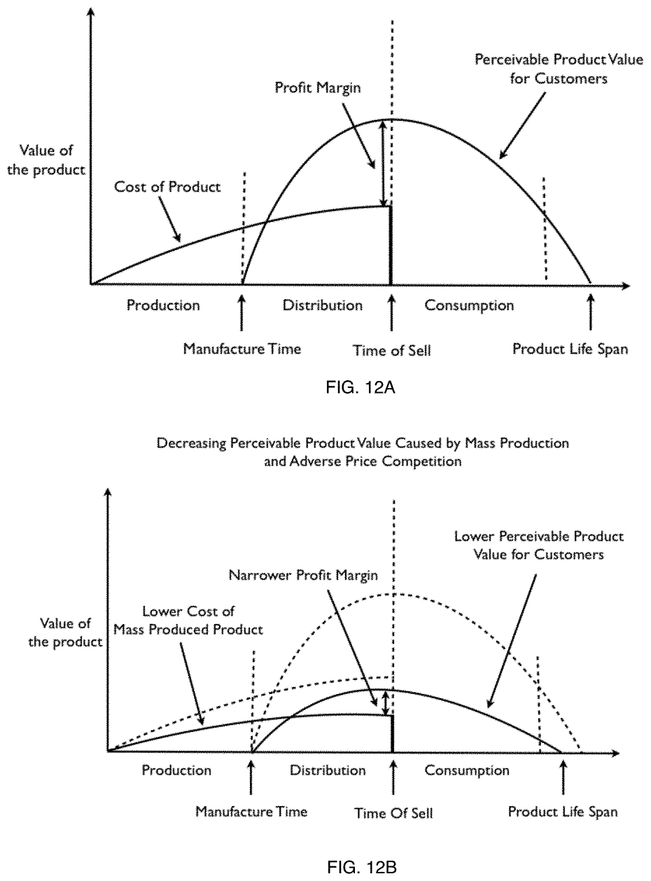

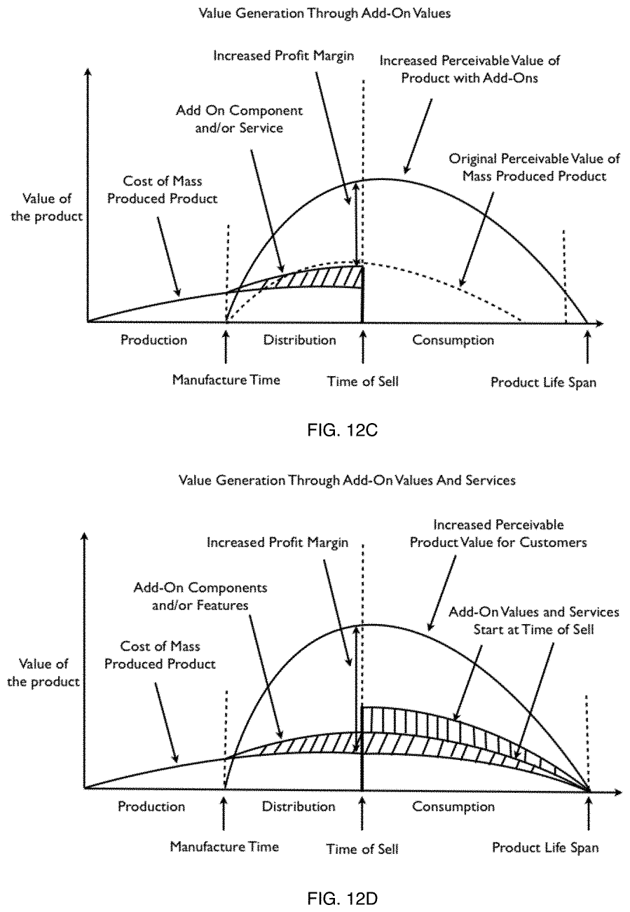

In FIG. 12A, the value of the product during its production, distribution and consumption phases is illustrated. When a product is manufactured, the cost associated with designing, producing, distribution, storing the product and etc are added on top of the original cost of the manufactured product, until the Time Of Sell. When a customer has perceivable value of the product that is higher than the cost of the product, and the product is ready to sell, and the customer has the access to purchase the product, the purchase takes place, this is recognized as the Time of Sell. The Prime Elements of Purchase are met at the Time Of Sell, that is what, when, where, why, how and who are all matched from both the consumer side and the seller side. The retailer at the Sales Point receives the net profit from the sell, which is the amount of money he/she receives from the customer, minus the cost of that product and the cost associated with the sell.

Profit Margin=Purchase Price−Costs Of Sell

Under the pressure of adverse price competition, illustrated in FIG. 5, and mass production aided by advanced technology, the unit cost of the generic product is lowered. This is caused by the higher efficiency in production, as well as a process of reducing resources added in the production, so that a lower cost product can better compete in the market.

Illustrated in FIG. 12B, this adverse competition in the market also causes a lower perceivable value of said product for a consumer. Because the mass produced product not only lost its value in scarcity, but also the quality of said product is lowered, caused by the reduction of resources in the production process.

For retailers, these make the products harder to sell, and also reduced the profit that they can get at Time Of Sell.

In FIG. 12C, add-on components and/or services are added to the generically produced product during the distribution phase, and increase its perceivable value for the consumers.

In FIG. 12D, add-on components and/or services are added to the generically produced product during the distribution and consumption phases, and increase its perceivable value for the consumers.

When customer buys product from seller at a Sale Point, all prime purchase elements are met, it is a contact point where both parties reaches agreement for the transaction to take place. It is also a good place to use add-on values to increase the perceivable values of the products. This is because the Where, How and Who elements are already set and met successfully at said sales point, and by making efforts on the What, When and Why elements, the seller can create add-on sales from existing sales, and/or generate new sales.

We human beings are social beings. We like to associate with people, and receive services from other people. Since we are physical beings, we have limitations on where we can receive in-person services. This can be concluded as local customized in-person services.

With advanced technology, it is foreseeable that many jobs that only have repeatable simple procedures will be replaced by robots. However, many jobs that requires high level of creativity, sophisticated inter-personal skills, personalized preferences and style still requires human beings to do the work.

In FIG. 12.D, the distribution and consumption process are transferred into a value generation process, which allows distributors, retailers and service providers to cooperate with the customers, add values to the product based on customer's preference and taste, and create a higher perceivable value for the customer.

This also increase the profit margin of the sell, and enables the parties that created these add-on values to receive compensations and/or rewards for their work. The majority of these add-on value payments and/or profits will be toward human labors offered by the service providers.

An example of this model is the DIY (Do It Yourself) clay painting retail store. This retailer provides a large amount of paintable clay models and in their stores, including vase, plate, animal sculptures and etc. Customers come to the store, select a clay model for their occasion, paint the model at the store using the painting kit provided by the store. After they are done with painting, they leave the painted clay object in the store for the store stuff to complete the finishing coat on the clay object, and burn it into a final product. The customer comes back to the store and pick up the finished product in one week.

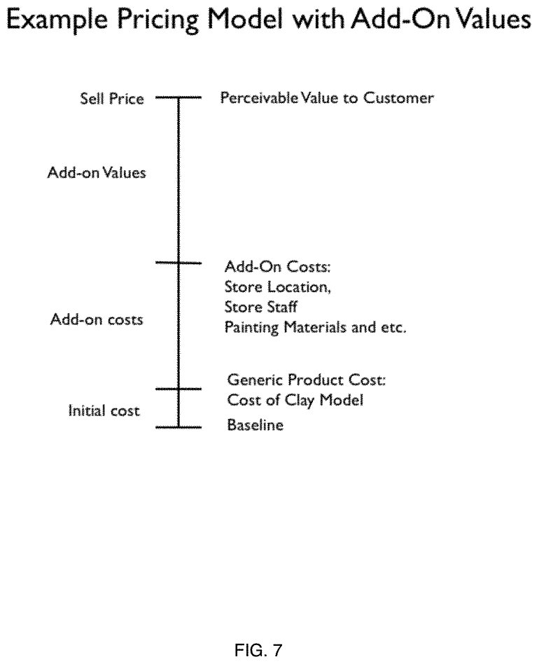

The store charges for the clay model and customers' time spent at the store. In this example, illustrated in FIG. 7, the cost of the mass produced generic product, which are the clay models, is very low. The customers are involved in the creation of the add-on values for the product, facilitated by store staff and resources. They adjust the product to their personal preferences and tastes, using the product customization kit provided by the store. This significantly increase the perceivable value of the product to the customer, they are willing to pay a premier price for the finished products. This is because these products now are instilled with their personal preferences, their personal experience. These products are dear to their hearts now.

The retailer receives a bigger profit margin by selling these customized products that has high perceivable value to the customers. The majority cost of the sell is to maintain the physical store location, store staff, painting material, clay models and etc.

The product line and/or logistics including product design, manufacture, sourcing, distribution, packaging, wholesale and retail is not easy to form, and is highly competitive FIG. 6. The parties among similar products are highly competitive to each other. A logistic chain of a product line may takes years to form and easily get disrupted. Sometimes, when a party in a logistic chain failed, it disrupts the entire logistic chain. For example, when a group of retailers go out of business, the stress is shared among all parties in the logistic chain, who depends on the retailers to sell the products.

In the traditional logistic chain, the retailers who sell the products receives payments from the customers, then pay other parties in the logistic chain. Retailers control the pricing of the products, and often reduce the selling prices because of the competition in the market. It is very difficult for parties who provide add-on components to ensure they get paid for their contribution, and it is very difficult to trace whether retailers have received payments for the enhanced products but do not distribute payments to the parties who create and contribute to said enhancements.

Part 14: Solution—LeafBill

The principle of this solution is that by adjusting the allocation of the distribution of the payment received from the sell of a product, we ensure that the human resource instilled into the product are compensated and paid. This in turn, ensures that these human assets will be recycled back into our economics system through human consumption.

Another principle of this solution is that by inserting add-on values as LeafBills on top of mass produced generic products, we provide a easy and visible way to add and instill add-on services and product components in the product distribution and consumption phases, and compensate for the add-on work at the Time Of Sell.

By adjusting the price of the product based on the number of units sold and/or the market demand for said product, we create an organic way to control the disruption of the market by mass production aided by machine.

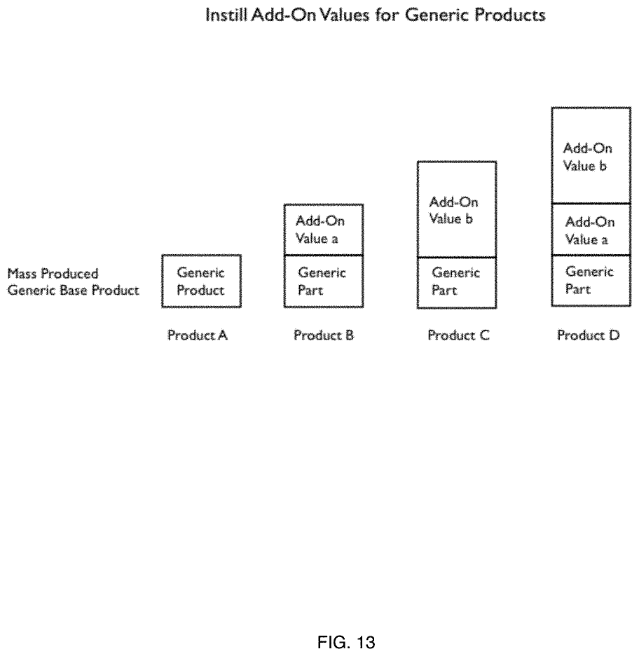

FIG. 13 illustrated that add-on components and/or services are instilled onto generic mass produced products. In this case, generic products serves as a media, it carries the specific add-on features, components and services, delivers them to the customers, to fulfill specific needs of customers. By combining different add-on value and/or add-on value sets with the generic products, and make them available to purchase in the market, we provide a flexible, customizable and adjustable product suite to the customers. This significantly increases the perceivable value of the products to the customers. Now these products are not only functional products, but are customized and tailored based on consumers' preferences, and fits into their personal styles.

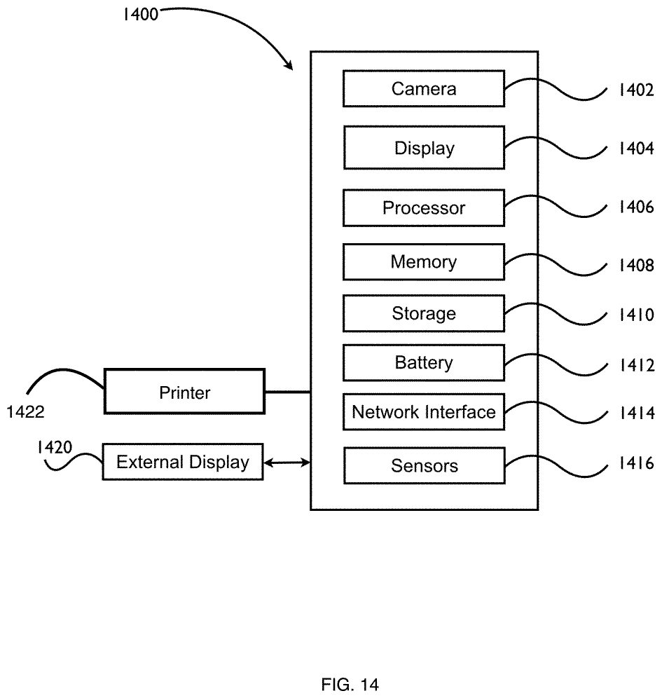

With reference to FIG. 14, in its most basic configuration, the LeafBill system 1400 comprises at least one processing unit or processor 1406 and system memory 1408, a display 1404, a camera and/or video camera 1402, a storage unit 1410 and network interface 1414. In embodiments, an application program is loaded into the memory 1408 of the system and executed by the system processor 1406, the system receives data through network interface 1414, store said data in system storage 1410, process and manage said data using the application program in the memory 1408, and display them in an iterative way on the system display 1404. System make has a plurality of external displays and/or devices. In one embodiment, the memory 1408 is provided by blockchain, the storage 1410 is supplied by the blockchain, an open distributed ledger managed by a peer-to-peer network, dynamically retrievable and accessible using smart contracts that are also stored on the blockchain. The storage 1410 may connect with internal and/or external data storage 2710 including database, backup disk, CD-ROM, data storage, cloud storage and network storage. The digital ledger and/or data record are stored in the storage provided by the custom configured computer systems in a peer-to-peer blockchain computer network. The data, digital ledger and/or data record are regularly backup and saved to internal and/or external data storage.

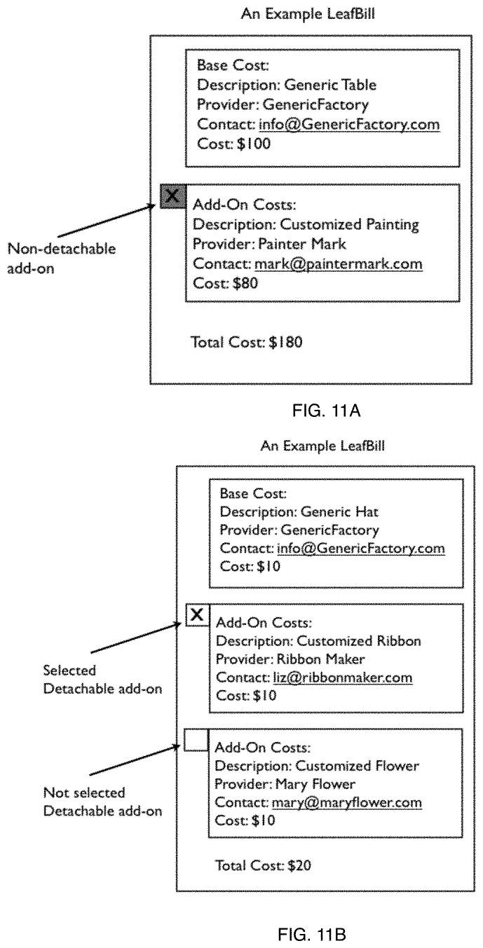

Depending on the exact configuration and type of LeafBill system 1400, memory 1408 may be volatile (such as RAM), non-volatile (such as ROM, flash memory, etc.), or some combination of the two. The LeafBill system 1400 may also has a printer and/or printing component and/or system 1422, and enabling said system to print out physical receipts 1700 and 1710 for customers, vendors and users FIGS. 11A, 11B, 15, 17A and 17B.

The LeafBill system 1400 can be further configured to interact with and/or be part of a point of sale system, on a touch screen mobile phone/tablet/TV/computer application system.

An embodiment of LeafBill system 1400 is a wireless touch screen device, such as a smart phone, a tablet, a mobile device and other devices with similar characteristics including a smart TV.

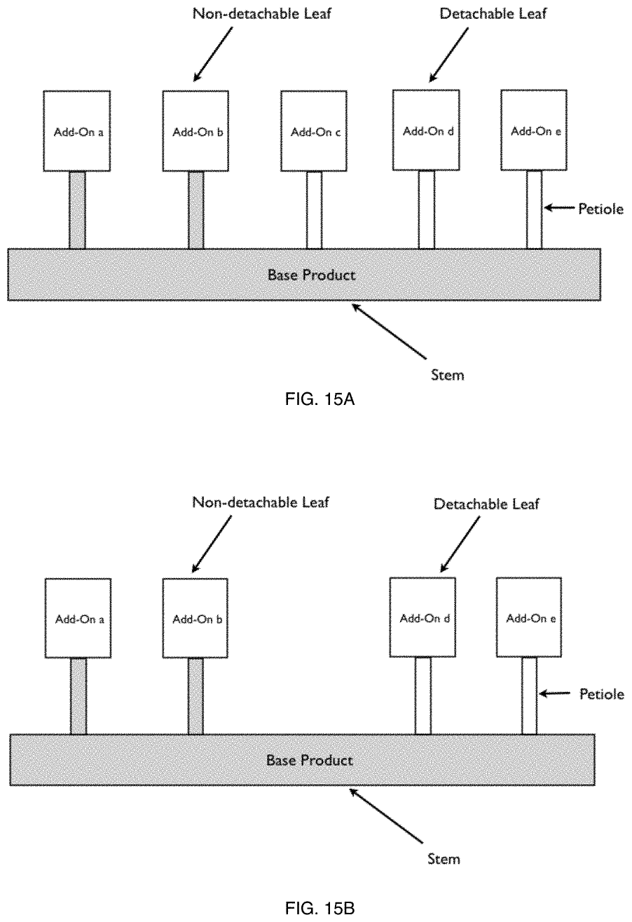

FIG. 15A illustrated a way how the add-on values can be instilled onto a generic product. For this structure, I named it LeafBill. Just like a leaf have leaflets, petiole and stem; a LeafBill has leaf (leaflet) and a connection part (petiole) that connects itself with the base product (Stem).

A LeafBill in its physical form is a set of tags, combined into one visible pricing component that serves as a new form of price tag in a retail environment. It lists add-on components and/or services of added onto an otherwise generic product, their add-on costs, based price of the generic product, other related information and the total price for the enhanced product.

It allows the customers to easily view, compare and select add-on components and/or service to purchase along with the generic product, and pay for said add-ons as separate payoffs to add-on service providers, and pay for the generic product to retailer, in one transaction at the Time Of Purchase. It allows the service providers to instill enhanced components and/or services as add-ons of products to increase the perceivable value of said product, and receive compensation for their work at Time Of Sell.

A LeafBill contains one or more Leaves. Each Leaf represents one add-on that is instilled into the product. It contains the cost of the add-on; title and/or short description of the add-on; contributor and/or service provider of this add-on; contact information of the contributor and/or service provider; and other related information of the add-on component and/or service.

Each Leaf is attached to the LeafBill through Petiole in two ways, one is non-detachable add-on, and the other way is detachable add-on.

For an add-on component and/or service that has been instilled into the product, and can not be easily removed, that add-on component and/or service is included as a Non-detachable Leaf in the LeafBill.

For example, if the product is a piece of furniture. A service provider has painted said piece of generic furniture with enhanced color themes at the store, to match with a customer's personal taste. This added on service is now part of the product. The product now needs to be purchased with the original generic furniture, along with enhanced painting service. As illustrated in FIG. 11A, this add-on service of painting is included as a Non-detachable Leaf of the LeafBill, the original generic furniture cost is included on the Stem of the LeafBill. Customer needs to pay the total cost of the LeafBill at checkout, which is the cost of the original furniture (Stem) and the cost of the customized painting (Leaf).

An example of a Detachable Leaf is a customer want to buy a hat in a store. The store sells a collection of varies hats. One of the hats has two add-on components attached onto the generically made hat, one is a flower, and the other one is a ribbon. Both these add-on components are included as Detachable Leaves on the LeafBill. The customer likes to have the ribbon on the hat, but does not like the flower. So when she purchases the hat at the checkout, she requested the store clerk to remove the flower from the hat, and its Detachable Leaf from its LeafBill. As illustrated in FIG. 11B, the customer only needs to pay for the Stem and one Leaf on the LeafBill, and purchases the generic hat with the ribbon add-on as the final product.

The Detachable and Non-detachable feature of LeafBill FIG. 15A and FIG. 15B makes it very easy to assemble and instill customized components and/or services into the product, and ensure the provider gets paid for his/her work. This allows ample opportunities for service providers to instill add-on values into generically made products, receive benefits for their work. At the same time, individual service providers help increase the perceivable value of the products for the customers, and attract the customer to purchase the products at a higher price. This may be the full-time or part-time job for the service providers.

The Petiole of the Leaf in the LeafBill allow the Leaf to be attached onto the Stem, which means it is the part to establish the relationship of a component and/or service, being added onto a product, and become part of the enhanced product, and make it payable at Time Of Sell.

The Petiole represents the partnership between the store owner and the service provider. It can be a non-detachable petiole or detachable petiole, depending on the type of customization and/or service.

The store owner gives the service provider the opportunity to sell their add-on components and/or services on top of their generic inventory. The service provider gives the store owner the opportunity to sell enhanced products at a higher price, attract customers and induce sells. It is a mutual beneficial partnership.

The service provider may pay the store owner a certain percentage from the sell of the add-on components and/or services, for store's cooperation and facilitation in the transactions, the displaying of the enhanced products to the customers, and other resources provided by the store. In this way, the store sells enhanced products at a higher price and gets a larger profit margin, and also receives benefits and/or commissions for the add-on components and/or services. For the store, these benefits and/or commissions are pure profits, and it does not incur additional cost for the store.

The service providers shall refine their styles, techniques and skills. So that they can establish unique add-on components and features to attract customers to make the purchase for the enhancements and/or services offered by them. They not only have a high level of creativity, refined style and taste, but also have sophisticated inter-personal skill. They are the local service providers and/or specialists, have their own customer base, and attract customers to the stores that have their enhanced products on display. These service providers and/or specialists may visit local stores in turns, helping local stores display and promote their enhanced products, and assist store in sales promotions, attract customers to the stores, and increase sales.

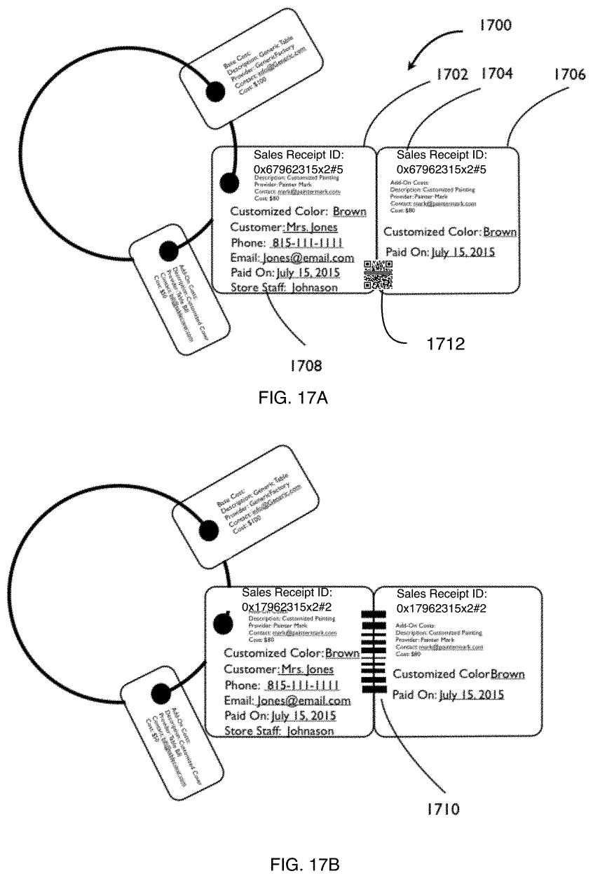

FIG. 17A is an illustration of LeafBill printout receipt 1700 for the order of an add-on service that the customer purchased with the enhanced product. A leaflet 1700 has two parts, one part is the receipt for the service provider 1702, and the other part is the receipt for the customer 1706. When the customer purchases the to-be-completed add-on service at the checkout, he/she pays for said service along with all other product and/or components included in the LeafBill. Because this add-on service still needs to be completed by the service provider, the customer needs to get a receipt as a proof for his/her payment for said service. Both the service provider part of the Leaflet 1702 and the customer part of the Leaflet 1706 has the same unique receipt number 1704, to validate the transaction. Customers fill in his/her contact information and customized request for the add-on service on the Leaflet 1708. The store clerk fills in the payment date to warrant that the add-on service has been paid for, and his/her name to validate the transaction. Customer tears out the customer part of the Leaflet 1706 and leaves the product at the store for the service provider to complete the add-on service. The service provider visits the store later that day, completes the add-on service for said product according to the customization request ordered by the customer. The service provider calls and/or informs the customer to let him/her know that the product is ready to pick up. The customer picks up the enhanced product from the store the next day.

Because the LeafBill and the Leaflet includes the service provider's customer support information, the customer can reach out to the service provider if he or she needs further customization or needs customer support for that add-on component and/or service.

Essentially, LeafBill encloses the transactions of add-on components and services into one bill and one transaction, so that more refined customer service and add-on components and/or services can be delivered to individual customers. The LeafBill receipt can also include product description, vendors' names, pricing, purchase information and other information related to the product and/or prototype FIGS. 17A and 17B.

Illustrated in FIG. 17B, a barcode 1710 is shared on both the service provider side 1702 and the consumer side 1706 of the Leaflet 1700. The LeafBill receipt can also be further configured and generated as a multipart receipt FIGS. 17A and 17B, positioning the provider side of the receipt and the consumer side of the receipt together so that an edge portion of one side connecting an adjacent edge portion of the other side, encoding and/or printing barcode and/or QR code along the edge portion and adjacent areas so that the same barcode and/or QR code is visible on both sides. This enables the user, provider and/or consumer easily separating the provider side of the receipt and the consumer side of the receipt along said edge. The make the comparison, verification of the Leaflet easier, and also increases the security and reliability of LeafBill. The barcode can also include other information such as the location of the store, and the type of the add-on component and/or service. Illustrated in FIG. 17A, a QR code 1712 is shared on both the service provider side 1702 and the consumer side 1706 of the Leaflet 1700. Because QR code can only be decrypted when the complete image is visible, this provides additional security by preventing users from fabricating false LeafLet by using either side of the LeafLet. In other word, the QR code can only be decrypted when both side of the LeafLet exist, and the LeafLet can be validated when both sides of the LeafLet are available for verification at the same time. A various encryption methods and mechanisms may be used including barcode, QR code and/or custom encryption methods to enable easy verification and secure transaction.

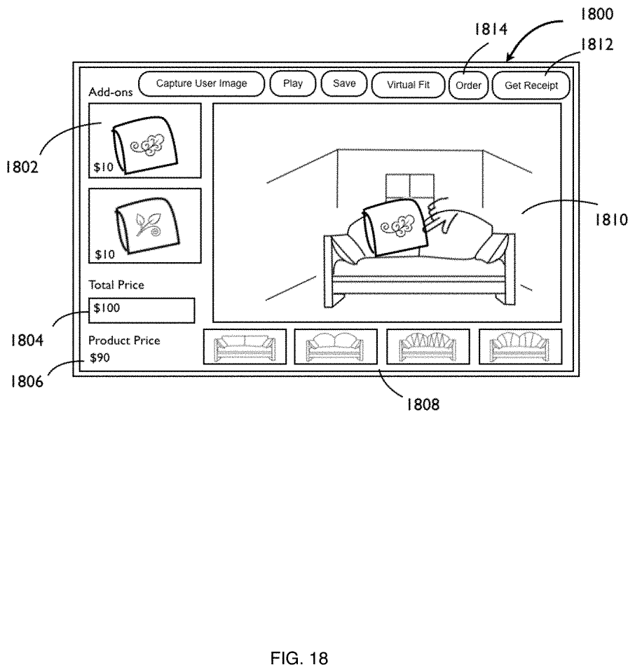

With reference to FIG. 18, an embodiment for implementation of a virtual fitting system, such as virtual fitting system 1800, make available on an electronic device, is used to assist the customer to virtually try on the add-ons and/or products and make their purchase decision. The customer use the camera 1402 to take a picture of their personal space, add images of products 1808, and images of add-on components and/or services 1802 on top of said photo, so that they can visualize how an add-on component 1802 looks with a generic sofa 1808, and how this sofa and pillow set looks in their living room on the graphic display area 1810 of said virtual fitting system. When the customer select the add-ons, the system automatically calculates the total price 1804 that includes the add-on 1802 and the base product 1806. The customer can print out the LeafBill receipt by click on the Get Receipt button 1812, or order the generic product and add-ons from their provider in one purchase by click on the Order and/or Buy button 1814. The LeafBill system can be further configured to be part of or interacts with a virtual fitting system, enabling consumers to virtually try on, purchase, order, preorder, bulk order, custom order products and prototypes.

Part 15: Digital LeafBill

Digital LeafBill is digital ledger and/or data record stored on memory, disk or network storage of custom configured computer systems in a peer-to-peer blockchain computer network, interacting with smart contracts and/or executable computer programs stored on the blockchain to digitally process, record, verify data and execute algorithms and/or computation processes. Digital LeafBill is accessible on the P2P blockchain network using smart contracts, protocols and/or executable computer programs.

Digital LeafBill and smart contract allows the process of credible transactions without third parties, and it can be configured to run automatically without human interference, self-executing and self-enforcing. The transactions are trackable and irreversible. The execution of a digital LeafBill transaction and smart contract and can be initiated using predefined algorithm, private and public key combination. LeafBill uses digital smart contracts to record the offer, acceptance, consideration and mutual agreement process of the contract, and use the recorded information for automated payment distribution upon the execution of the contract based on predefined terms. LeafBill records transaction-based state transitions, and make it tamper-proof, self-executing and self-enforcing. LeafBill can be further configured to automatically recording transaction-based state transitions of the offering, consideration, acceptance and mutual agreement process of contracts based on predefined terms and configurations.

Part 16: Blockchain and Smart Contract

A blockchain is a growing list of records, called blocks, linked together using cryptography. Each block contains a cryptographic hash of the previous block, a timestamp, and transaction data, generally referred to as a Merkle tree. Blockchain is temper proof and resistant to modification of the data stored on the blockchain. It is an open distributed ledger that record transactions and stored executable programs and digital smart contracts efficiently, make it verifiable and recorded permanently on the chain. A blockchain is typically managed by a peer-to-peer network collectively, enables decentralized consensus.

Blockchain networks such as Ethereum and Bitcoin provide decentralized virtual machines, which provide storage of digital smart contracts and can execute digital smart contracts using peer-to-peer network of public nodes.

A digital smart contract is an executable computer program stored on the blockchain to digitally process, verify and execute an algorithm and/or computation process stored in said digital smart contract.

Part 17: Record Contract Using Digital LeafBill

A contract is a legally binding agreement that recognizes and governs the rights and duties of the parties to the agreement. An agreement typically involves the exchange of goods and services for money and/or resources. A contract usually requires an offer, acceptance, consideration and mutual agreement to be bound.

Digital LeafBill uses cryptography to identify the parties involved in a contract. Each party has a unique identifier for its digital payment address and/or cryptocurrency wallet address, also referred to as the unique address of said party. Each payment address has a public key, and a private key. Only the owner of said payment address has the private key. Anyone can send cryptocurrency to said payment address, but only the owner who has said private key can withdraw cryptocurrency from said payment address. Using digital LeafBill and smart contract, a user needs to verify that he/she is the owner of said payment address by enter the correct public and private keyset, before he/she can perform transactions that are only enabled for the owner of said payment address. For example, an owner can only withdraw cryptocurrency from a payment address after providing the correct public and private keyset of said payment address. All transactions and keys are protected by cryptographic on the blockchain to ensure secure and reliable transactions.

Digital LeafBill uses algorithms and computer programs to translate a contract and its terms into digital transaction-based state transitions, make it verifiable and recorded on the blockchain, make the transactions temper-proof, trackable and irreversible. Digital LeafBill uses digital smart contracts to record the payment addresses of the parties, the offer, acceptance, consideration and mutual agreement process of the contract, and use the recorded information for automated payment distribution upon the execution of the contract.

Part 18: LeafBill Registration

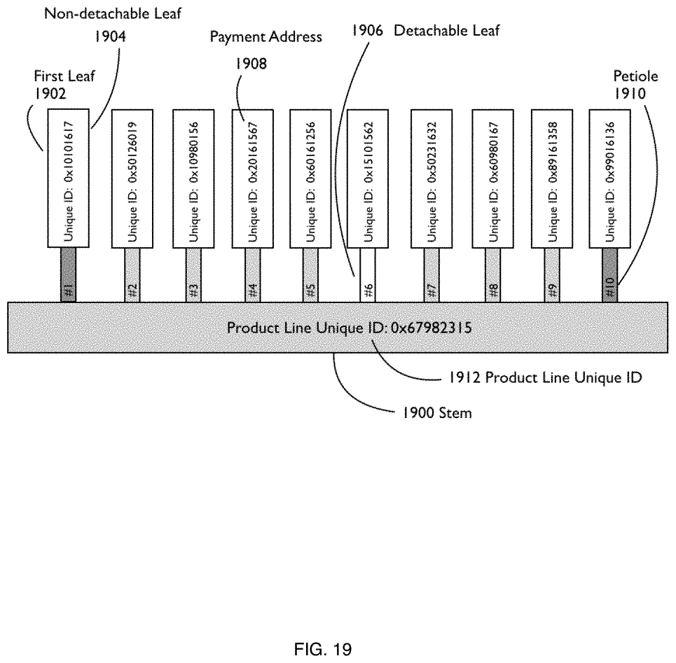

FIG. 19 is a diagram illustrating an embodiment of LeafBill using unique identifiers for the product line and payment addresses. Each product line and or product branch has a unique id 1912. The initiator create said product line with said unique id, add his/her own payment address on the first leaf 1902. Each contributor has a unique payment address, which is used to access smart contract, process transactions, and receive payment distributions. A plurality of encryption algorithms, and a plurality of public and private keysets are used for verifying user's ownership of a payment address, enabling secure transactions using the digital smart contracts. The leaf of a LeafBill can be detachable and/or nondetachable. A detachable leaf 1906 means that a contributor can be removed from a product line after being added to said product line, with his/her consent and/or based on terms predefined in contracts and/or digital smart contracts. A nondetachable leaf 1904 means that a contributor can not be removed from a product line after being added to said product line

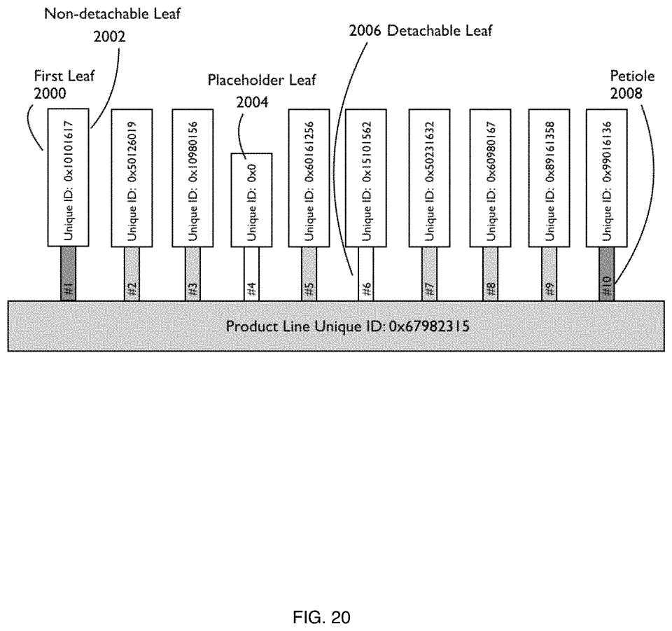

FIG. 20 is a diagram illustrating an embodiment of LeafBill using placeholder leaf. When a role in a product line and/or product branch is not filled in by any contributor, a placeholder leaf 2004 is used to hold the place for a future candidate who would like to apply for said role. When a contributor is removed from a product line and/or product branch, his/her payment address is removed from said product line and/or product branch and replace with a placeholder leaf 2004, until a new contributor applied for said role and is approved to be added to said product line and/or product branch.

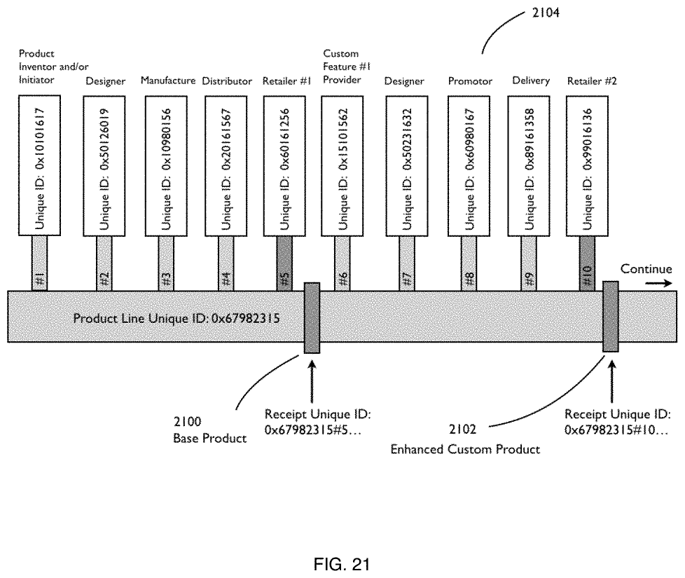

FIG. 21 is a diagram illustrating an embodiment of LeafBill that has one product line, with the custom product line directly extended from the base product line. Each product line and/or product branch has a unique identifier. Upon product sell, the LeafBill system dynamically generating a unique payment receipt id by combining the unique identifier of the product line or product branch, and the sequential number of the last contributor contributed to said product, creating an unique receipt id for said product sell 2100 and 2102.

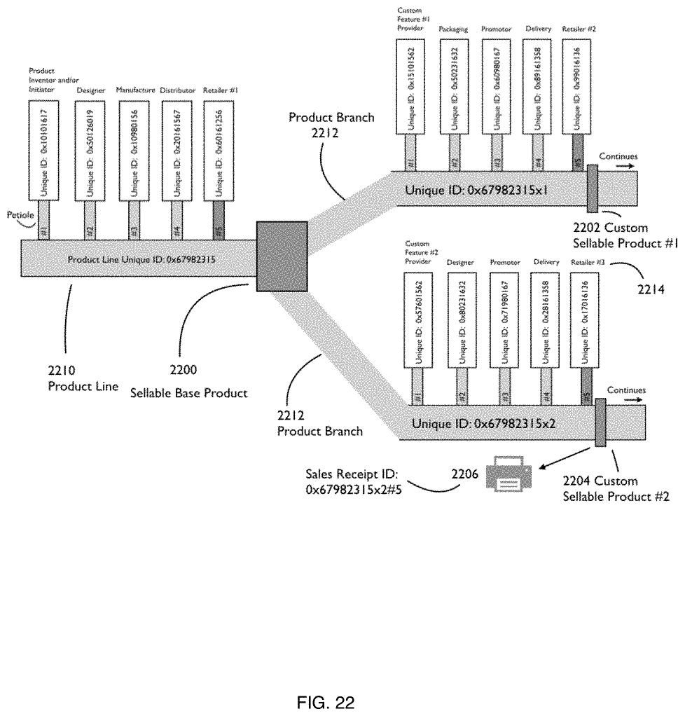

FIG. 22 is a diagram illustrating an embodiment of LeafBill that has two branches, with two different custom product branches extending from the main base product branch. Each product line 2210 and/or product branch 2212 has a unique identifier. Upon product sell, the LeafBill system dynamically generating a unique payment receipt id by combining the unique identifier of the product line or product branch, and the sequential number of the last contributor contributed to said product, creating an unique receipt id 2206 for said product sell.

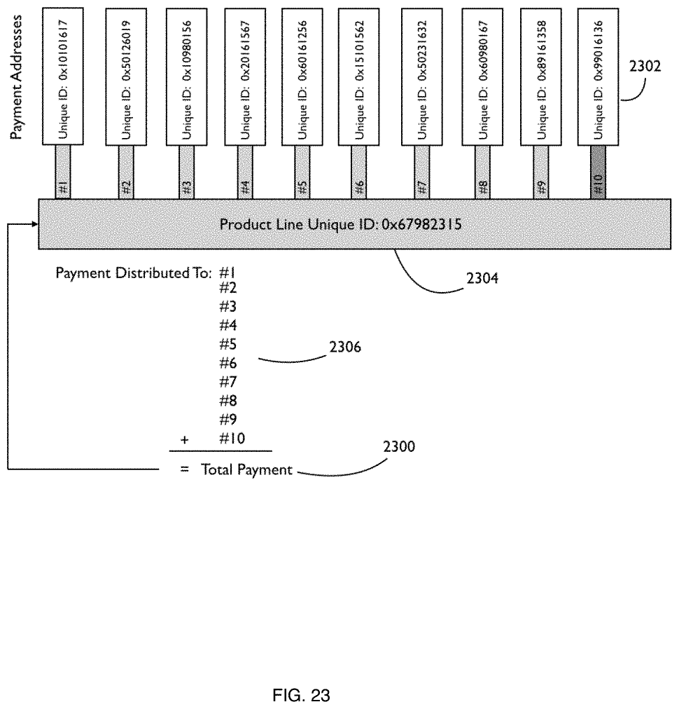

FIG. 23 is a diagram illustrating an embodiment of LeafBill showing that the sum of payment distributions 2306 to all individual contributors 2302 equal to the total payment 2300 received at that payment address of the product line.

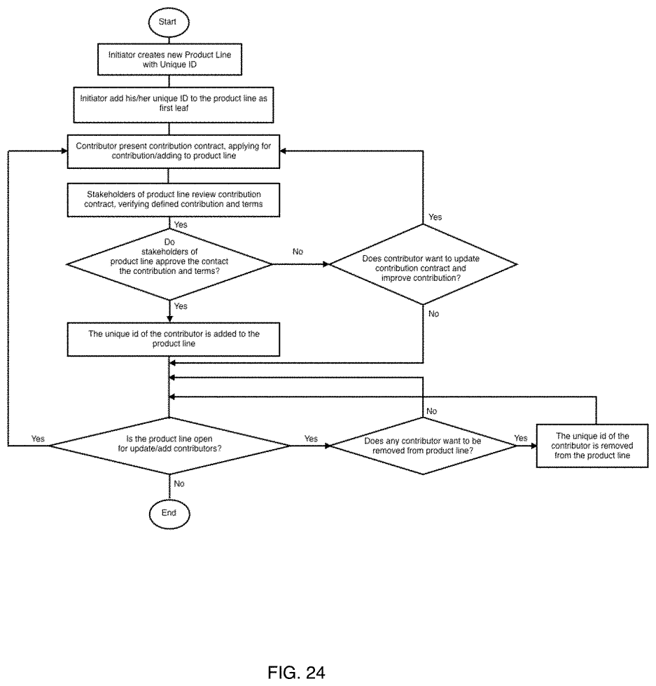

FIG. 24 is a flowchart illustrating the process of using LeafBill to record the offer, acceptance, consideration and mutual agreement process of the contract for adding a contributor to a new product line.

An initiator creates a new product line and the unique identifier for said new product line 1912, and registered the new LeafBill on the blockchain. The initiator also created the LeafBill smart contracts for said new product line, store said LeafBill smart contracts on the blockchain. Said initiator add his/her own unique payment address as the First Leaf 1902 on the LeafBill. A contributor such as a product designer reviewed the information of the new product line, completed a few design proposals for the product. Said contributor fill in an application form, applying for contributing and being added to the product line. The stockholders of the product line reviewed his/her application and proposals, verified the information and contract terms. Upon approval, the unique payment address of the contributor is added to the product line and/or product branch. Said product line and/or product branch continues said process of adding new contributors until it is closed for new applications. Contributors who have been added to the product line and/or product branch can also be removed from product line and/or product branch upon his/her consent and/or predefined terms in the contract and/or digital smart contract.

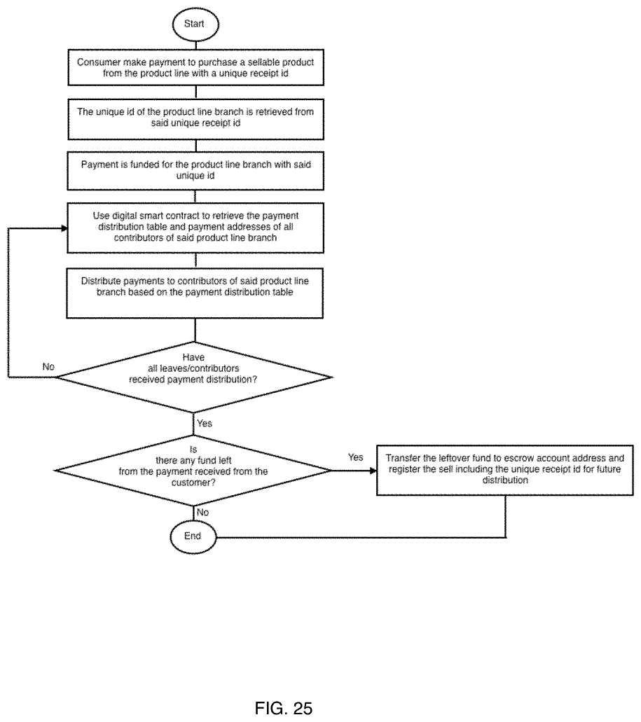

FIG. 25 is a flowchart illustrating the process of using LeafBill making automated payment distribution to individual contributors upon receiving payment from selling the product. The LeafBill system enables automatic payment distribution by retrieving the payment addresses and contracts of all contributors who contributed to said product of said product sell using said unique payment receipt id, simultaneously distribute the payment received from said product sell to said all contributors based on the data stored in said digital ledger and/or data record.

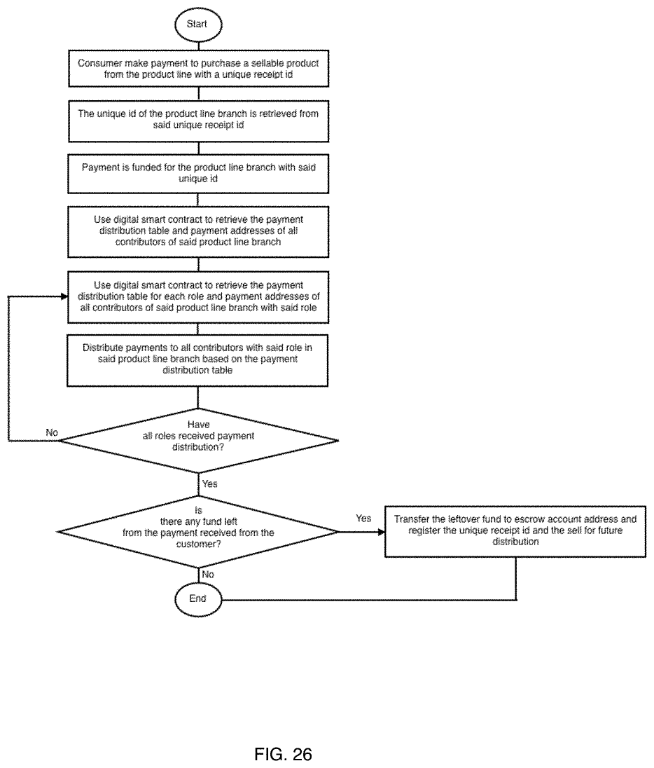

FIG. 26 is a flowchart illustrating the process of using LealBill making automated payment distribution to individual contributors bases on their roles upon receiving payment from selling the product. The LeafBill system uses sequential numbers to register a list of contributors with their payment addresses and roles 2104 on said digital ledger. Based on the terms of the contract, some contributors who share the same role may evenly and/or proportionally share a predefined percentage of payment received from the product sell.

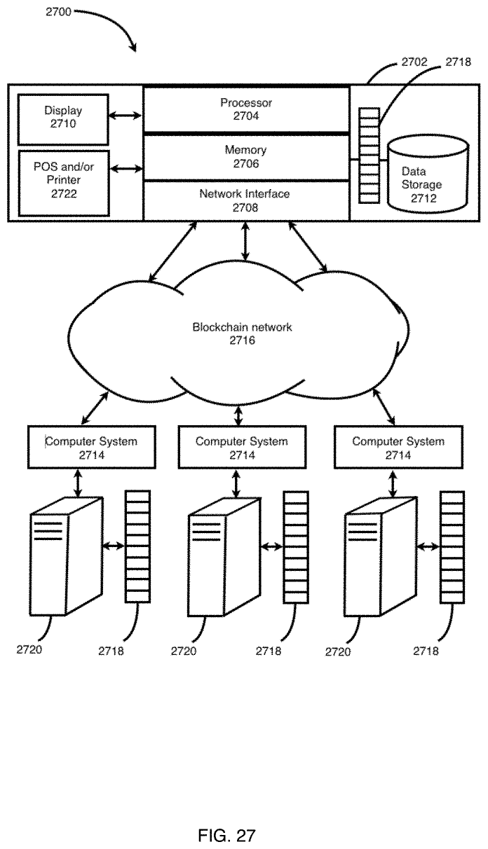

FIG. 27 is an illustration of one embodiment of a LeafBill system in the embodiment of an custom configured computer system 2700 in a peer-to-peer blockchain computer network 2716 for enabling an automated recording of contracts and distribution of payments to contributors of a product line according to a process of automatic recording payment addresses, transactions, contracts and state transitions of contracts, enabling automatic payment distribution using a plurality of algorithms, digital smart contracts and digital ledgers. The LeafBill system includes a Processor 2704, a Memory 2706 and a Network Interface 2708 to connect with the Blockchain network 2716. It uses the Processor 2704 for automatically creating and using unique identifiers for identifying product lines 2210, product branches 2212, users, contributors 2104, payment addresses 1908, transactions, timestamps, contracts 2804 and elements of contracts, accessible to a plurality of computer systems in said peer-to-peer blockchain computer network 2716. It has a memory 2706 connected with said processor 2704 for storing said unique identifiers. Said LeafBill system uses a plurality of algorithms and digital smart contracts stored in said memory 2706, enabling automated recording of unique payment addresses 1908, contracts 2804, transaction-based state transitions of the offering, consideration, acceptance and mutual agreement process of contracts, creating a digital ledger and/or data record 2718 stored in said memory. The LeafBill system also uses a plurality of encryption algorithms, and a plurality of public and private keysets, for verifying user's ownership of a payment address, enabling secure transactions using the digital smart contracts. The LeafBill system uses sequential numbers to register a list of contributors 2104 and their roles on said digital ledger 2718. The LeafBill system uses sequential numbers and/or unique ids to register a plurality of product branches 2212 derived from the product lines 2210, appending said sequential numbers and/or unique ids to said unique identifiers of said product lines 2210, enabling each product branch has an unique identifier 2202 and 2204. Upon recording product sell, the LeafBill system dynamically generating a unique payment receipt id by combining the unique identifier of the product line or product branch, and the sequential number of the last contributor contributed to said product 2204, creating an unique receipt id for said product sell 2206. The LeafBill system can print out physical receipt 1700 with said unique receipt id 2206. The LeafBill system enables automatic payment distribution by retrieving the payment addresses and contracts of all contributors 2214 who have contributed to said product 2204 of said product sell using said unique payment receipt id 2206, simultaneously distribute the payment received from said product sell to said all contributors based on the data stored in said digital ledger and/or data record 2718. The LeafBill system is an custom configured computer system 2700 in a peer-to-peer blockchain computer network 2716, and said digital ledger and/or data record 2718 is timestamped, encrypted and stored in the blockchain network 2716, saved and stored on a plurality of ledgers 2718 of peer-to-peer blockchain network public nodes 2714, make it verifiable and recorded permanently on the blockchain.

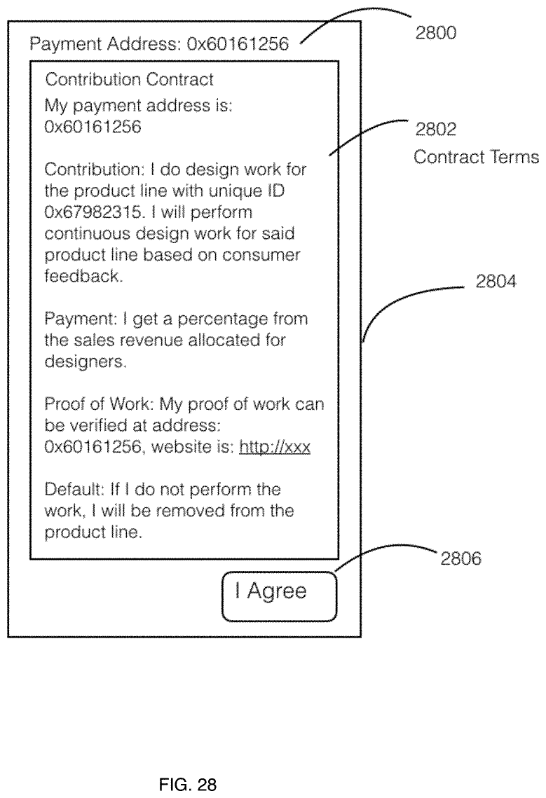

FIG. 28 is an illustration of one embodiment of a contract used in LeafBill system. A contributor has a unique payment address 2800. Said contributor reviews the information of a product line, completes a few design proposals for the product, and submit a contract offer 2804, applying for contributing and adding to the product line. The contract 2804 includes contract terms 2802, and can be created from legal contract templates and are specially designed and created for this occasion. Contributor can select the contract template his/she would like to use, and fill in the needed information to customize said contract. The LeafBill system offers a plurality of legal contract templates and/or links of websites that provide the legal contract templates for people to use.

The formation of a contract requires an offer, acceptance, consideration, mutual intent and mutual acceptance to be bound. Each party must have the capacity to enter into the contract. Said contract is digitally signed by the contributor using his/her payment address, public and private keyset. Upon accepting his/her contract offer, said contract is digitally signed by the stakeholders of said product line. Mutual acceptance is reached when both parties have digitally signed said contract. Said contract is then recorded on the digital ledger, and said contributor's payment address, role and related information are added to the list of contributors 2104 of the product line. After said contributor contribute to said product line, upon selling products from said product line, said contributor will receive automatic payment distribution 2306 from the sell, based on the terms predefined in said mutually agreed contract.

The memory 2706 of the LeafBill system enables automated recording of unique payment addresses, contracts, transaction-based state transitions of the offering, consideration, acceptance and mutual agreement process of contracts, creating a digital ledger and/or data record stored in said memory.

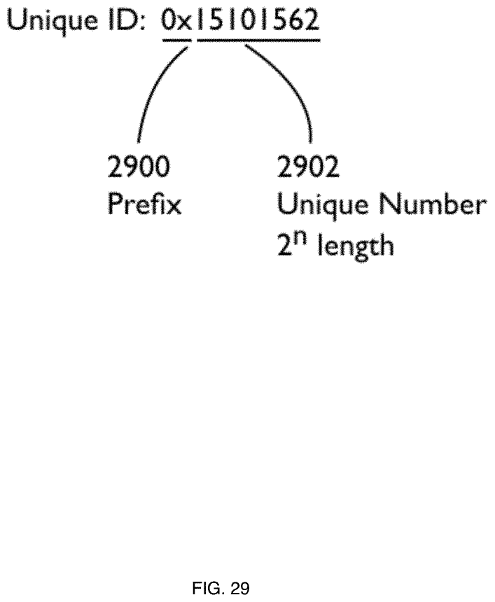

FIG. 29 is an illustration of one embodiment of a unique identifier. A unique identifier has a prefix part, and a unique number following said prefix part.

Part 19: Benefits of LeafBill

LeafBill helps stores to benefits from the creativity and specialty offered by individual service providers, and receives profits from the sell.

LeafBill helps stores to sell enhanced products at higher prices, attract customers and increase store sales.

LeafBill helps service providers to have a reliable way to instill their creativity and specialty on top of generic products, an efficient way to display these enhanced products and make them available to sell, and receive benefits from the sells of these add-on components and/or services. This effectively transfers their creativity and specialty into income generating resources for them; at the same time, offers enhanced services and better products for the consumers.

LeafBill is very flexible. A store owner may decide to sell generic products in his/her store, along with enhanced products using LeafBills. LeafBills can integrate easily with tradition Point Of Sale systems, and check out machines. A store owner can adapt with LeafBill based on his/her own pace on learning new technology, personal comfort zone, education level, technology savvy level, desire to change and other criteria.

Service providers may have their own boutique stores. Or several service providers may jointly own a store, have their enhanced products on display and make available to sell, and take turns to work at the store and provide enhanced services to the customers.

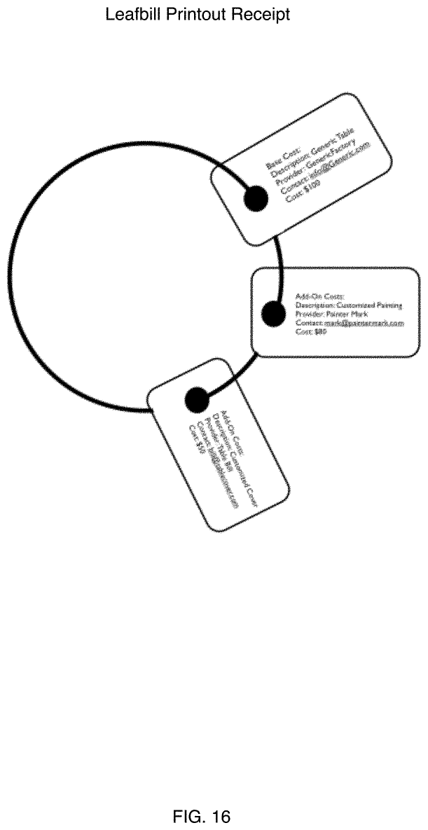

LeafBill is easy to implement. FIG. 16 shows a hand-made LeafBill. Individual services providers has Leaves for their add-on components and/or services. Working with the store owner, they add their add-on components and/or services on top of the generic products, and add their leaves to the Stem of the LeafBill. It is like add another key to a key chain. It is a flexible, easy and visible way to include add-ons as part of a product, display said added value, and receive compensation for the added value upon the sell of the product.

LeafBill is a transparent and visible way to display the additional enhancement and/or work instilled onto the product. This is ensures that service providers will try to provide high quality work as add-on components and/or services of the product. Because they get paid for their add-ons, the quality, uniqueness, style and other attributes of their add-ons directly decides whether customers will buy their add-ons as part of the product. It is also highly visible to the consumers who provides which add-on component and/or service. Consumers may become loyal customers for particular service providers, because the match in their style and taste, or because of the quality of the work, or because on-going services, or because the inter-personal skill of the service provider and etc.

LeafBill creates a sale point where in-personal, one-on-one relationship is established between a service provider and a customer. This helps the service provider to offer personalized and customized services to the customer. It also in general, helps our society to become a better communicated, integrated community.

For the store owners, because LeafBill helps them to offer enhanced products to the customers, they can sell products at a higher price and get higher profit margin. They may also get profit and/or commission out of the sell of the add-on components and/or features. This creates incentives for the store owners to attract and maintain a healthy amount of service providers partnering with the store, and work at the store.

For the consumers, LeafBill enables them to get customized products and/or services tailored to their preferences. It makes shopping a much more interesting experience. For the customers, buying a product and receiving high quality tailored consumer services is equally important and valuable.

LeafBill provides transparent and visible way to display the contributors of a product and their compensation at Time Of Sell. Consumers are clearly aware of what they are paying for, and who receives which portion of the pay off from the sell. This creates an organic way to create a healthy transaction flow for the local economy.

Like the “Buy Local, Buy Organic” campaign, consumers have an increasing awareness and conscious on contributing to their local community, and maintain a healthy local economy. Knowing that they are paying for high quality of service provided by individual local service providers, who can provide regular, on-going customized services to them in-person, attract them to pay a higher price for the enhanced product with add-on components and/or services.

LeafBill also provides an easy, visible, organic and effective way to monitor the proper usage of LeafBill. Each Leaf clearly identifies the service provider and its add-on component and/or feature. Consumer can clearly identifies what are the add-on component and/or feature that they have included in their purchase, and who get paid for that add-on at the check out. The LeafBill includes the contact information and/or customer support contact of the service provider, customer can send their feedback to the service provider, and communicate with the service provider.

Since the service providers do not offer the entire product, but instead, provide specific add-on components and/or services to the products, tailored to a specific consumer group, based on their style and taste. They are not competing with the retailers for their product line, distribution channel and/or retail stores. Just like artists are not competing with galleries, but instead they depends on each other. The relationship between service providers and store owners shall also be a mutual beneficial partnership, and creates a win-win solution for both parties.

While this invention has been described in terms of a preferred embodiment, there are alterations, permutations, and equivalents that fall within the scope of this invention. It should also be noted that there are many alternative ways of implementing both the process and apparatus of the present invention. It is therefore intended that the invention be interpreted as including all such alterations, permutations, and equivalents as fall within the true spirit and scope of the present invention.

Although the invention is described herein with reference to the preferred embodiment, one skilled in the art will readily appreciate that other applications may be substituted for those set forth herein without departing from the spirit and scope of the present invention.

This knowledge and this invention is documented here so that it can be properly preserved and shared among people who may use and improve this knowledge to enhance people's lives. This is under the fundamental principle, that we, human beings, shall proliferate and prosper as a society.

What is claimed is:

1. A method for enabling an automated recording of contracts and distribution of payments to contributors of a product line according to a process of automatic recording payment addresses, transactions, contracts and state transitions of contracts, enabling automatic payment distribution using a plurality of algorithms, digital smart contracts and digital ledgers via custom configured computer systems in a peer-to-peer blockchain computer network, said method comprising the steps of:
a. providing a processor for automatically creating and using unique identifiers for identifying product lines, product branches, users, contributors, payment addresses, transactions, timestamps, contracts and elements of contracts, accessible to a plurality of computer systems in said peer-to-peer blockchain computer network;
b. providing a memory connected with said processor for storing said unique identifiers;
c. providing a plurality of algorithms and digital smart contracts stored in said memory, enabling automated recording of unique payment addresses, contracts, transaction-based state transitions of the offering, consideration, acceptance and mutual agreement process of contracts, creating a digital ledger and/or data record stored in said memory;
d. providing a plurality of encryption algorithms, and a plurality of public and private keysets, for verifying user's ownership of a payment address, enabling secure transactions using the digital smart contracts;
e. providing a configuration of said processor to use sequential numbers to register a list of contributors with their payment addresses and roles on said digital ledger;
f. providing a custom configuration for said processor to use sequential numbers and/or unique ids to register a plurality of product branches derived from the product lines, appending said sequential numbers and/or unique ids to said unique identifiers of said product lines, enabling each product branch has an unique identifier;
g. providing a configuration for the computer system to record a product sell, dynamically generating a unique payment receipt id by combining the unique identifier of the product line or product branch, and the sequential number of the last contributor contributed to said product, creating an unique receipt id for said product sell;
h. providing a custom configuration for the computer system, enabling automatic payment distribution by retrieving the payment addresses and contracts of all contributors who contributed to said product of said product sell using said unique payment receipt id, simultaneously distribute the payment received from said product sell to said all contributors based on the data stored in said digital ledger and/or data record.

2. The method of claim 1, wherein the unique payment receipt id further including a timestamp of the time when said sell occurs.

3. The method of claim 1, wherein the sequential number of the contributor is associated with his/her role in the product line and/or product branch.

4. The method of claim 1, wherein the processor is further configured to automatically recording transaction-based state transitions of the offering, consideration, acceptance and mutual agreement process of contracts based on predefined terms and configurations.

5. The method of claim 1, wherein said memory is further configured to connect with internal and/or external data storage, and said digital ledger and/or data record are regularly backup and saved to said internal and/or external data storage.

6. The method of claim 1, wherein said computer system is further configured to connect with a printer system, enabling rendering and/or printing out digital and/or physical receipts, including custom multipart receipts for customers and vendors.

7. The method of claim 5, wherein said printer system is configured for creating a multipart receipt having the provider side of the receipt and the consumer side of the receipt joining together and made separable at edges where matching barcode and QR code is encoded, enabling easy verification and secure transaction.

8. The method of claim 1, wherein said computer system is further configured to interacts with and/or be part of a point of sale system, on a touch screen mobile phone/tablet/TV/computer application system.

9. The method of claim 1, wherein said computer system is further configured to be part of or interacts with a virtual fitting system, enabling consumers to virtually try on, purchase, order, preorder, bulk order, custom order products and prototypes.

10. The method of claim 1, wherein said receipt is further configured to include product description, vendors' names, pricing, purchase information and other information related to the product.

11. The method of claim 1, wherein the contracts further including contracts created from legal contract templates, filled in and completed with information provided by the contributors and/or users of said system.

12. The method of claim 1, wherein the payment addresses of the contributors can be of the types of detachable and/or nondetachable from the product line and/or product branch after being added to said product line and/or product branch.

13. A custom configured computer system in a peer-to-peer blockchain computer network for enabling an automated recording of contracts and distribution of payments to contributors of a product line according to a process of automatic recording payment addresses, transactions, contracts and state transitions of contracts, enabling automatic payment distribution using a plurality of algorithms, digital smart contracts and digital ledgers, said system comprising:
a. a processor for automatically creating and using unique identifiers for identifying product lines, product branches, users, contributors, payment addresses,
transactions, timestamps, contracts and elements of contracts, accessible to a plurality of computer systems in said peer-to-peer blockchain computer network;
b. a memory connected with said processor for storing said unique identifiers;
c. a plurality of algorithms and digital smart contracts stored in said memory, enabling automated recording of unique payment addresses, contracts, transaction-based state transitions of the offering, consideration, acceptance and mutual agreement process of contracts, creating a digital ledger and/or data record stored in said memory;
d. a plurality of encryption algorithms, and a plurality of public and private keysets, for verifying user's ownership of a payment address, enabling secure transactions using the digital smart contracts;
e. a configuration of said processor to use sequential numbers to register a list of contributors with their payment addresses and roles on said digital ledger;
f. a custom configuration for said processor to use sequential numbers and/or unique ids to register a plurality of product branches derived from the product lines, appending said sequential numbers and/or unique ids to said unique identifiers of said product lines, enabling each product branch has an unique identifier;
g. a configuration for the computer system to record a product sell, dynamically generating a unique payment receipt id by combining the unique identifier of the product line or product branch, and the sequential number of the last contributor contributed to said product, creating an unique receipt id for said product sell;
h. a custom configuration for the computer system, enabling automatic payment distribution by retrieving the payment addresses and contracts of all contributors who contributed to said product of said product sell using said unique payment receipt id, simultaneously distribute the payment received from said product sell to said all contributors based on the data stored in said digital ledger and/or data record.

14. A system for enabling an automated recording of contracts and distribution of payments to contributors of a product line according to a process of automatic recording payment addresses, transactions, contracts and state transitions of contracts, enabling automatic payment distribution using a plurality of algorithms, digital smart contracts and digital ledgers using custom configured computer systems in a peer-to-peer blockchain computer network, said system comprising:
a. a processor for automatically creating and using unique identifiers for identifying product lines, product branches, users, contributors, payment addresses, transactions, timestamps, contracts and elements of contracts, accessible to a plurality of computer systems in said peer-to-peer blockchain computer network;
b. a memory connected with said processor for storing said unique identifiers;
c. a plurality of algorithms and digital smart contracts stored in said memory, enabling automated recording of unique payment addresses, contracts,
transaction-based state transitions of the offering, consideration, acceptance and mutual agreement process of contracts, creating a digital ledger and/or data record stored in said memory;
d. a plurality of encryption algorithms, and a plurality of public and private keysets, for verifying user's ownership of a payment address, enabling secure transactions using the digital smart contracts;
e. a configuration of said processor to use sequential numbers to register a list of contributors with their payment addresses and roles on said digital ledger;
f. a custom configuration for said processor to use sequential numbers and/or unique ids to register a plurality of product branches derived from the product lines, appending said sequential numbers and/or unique ids to said unique identifiers of said product lines, enabling each product branch has an unique identifier;
g. a configuration for the computer system to record a product sell, dynamically generating a unique payment receipt id by combining the unique identifier of the product line or product branch, and the sequential number of the last contributor contributed to said product, creating an unique receipt id for said product sell;
h. a custom configuration for the computer system, enabling automatic payment distribution by retrieving the payment addresses and contracts of all contributors who contributed to said product of said product sell using said unique payment receipt id, simultaneously distribute the payment received from said product sell to said all contributors based on the data stored in said digital ledger and/or data record.

15. The system of claim 14, wherein said system further including and/or interacting with a printer component, enabling printing out multipart receipts including receipt id, product information, pricing, barcode, QR code and/or custom encryption methods for enabling easy verification and secure transaction.

16. The system of claim 15, wherein said printer further configured for generating the multipart receipts, positioning the provider side of the receipt and the consumer side of the receipt together so that an edge portion of one side connecting an adjacent edge portion of the other side, encoding and/or printing barcode and/or QR code along the edge portion and adjacent areas so that the same barcode and/or QR code is visible on both sides, enabling user separating the provider side of the receipt and the consumer side of the receipt along said edge.

17. The system of claim 14, further configured to automatically transfer the leftover fund from the payment distribution to an escrow account and register the unique receipt id and the sell in the digital ledger for further distribution.

18. The system of claim 14, wherein said digital ledger is further saved and stored on a plurality of ledgers of custom configured computer systems and/or public nodes in a peer-to-peer blockchain computer network.

19. The system of claim 14, further including an internal and/or external data storage including database, backup disk, CD-ROM, data storage, cloud storage and network storage.

20. The system of claim 14, wherein the product line is further configured to be extended into a plurality of product branches, each has a unique id.

21. The system of claim 14, further configured to be part of or connected to a point of sale system in a retail environment.

22. The system of claim 14, further configured to interact with an online shopping and/or e-commerce system.

23. The system of claim 14, further configured to be part of or interacts with a virtual fitting system, enabling consumers to virtually try on, purchase, order, preorder, bulk order, custom order products and prototypes.
